(19) United States
(12) Patent Application Publication
(10) Pub. No.: US 2008/0155409 A1
(43) Pub. Date: Jun. 26, 2008

(54) Internet search engine

(76) Inventor: Andy Santana, North Bergen, NJ (US)

Correspondence Address: WALTER J. TENCZA JR., 100 Menlo Park, Suite 210, Edison, NJ, 08837, US

(21) Appl. No.: 11/309,937

(22) Filed: Nov. 2, 2006

Related U.S. Application Data
(63) Continuation-in-part of application No. 11/309,086, filed on Jun. 19, 2006, now abandoned.

(51) Int. Cl. G06F 3/048; G06F 21/00

(52) U.S. Cl. 715/706; 726/3

(57) ABSTRACT

A computer processor is programmed to provide a search engine service to one or more members. The search engine service may be programmed to assist each member in accessing the Internet. The search engine service may cause a navigation buddy to be displayed on a computer monitor screen. The navigation buddy is typically a displayed character. The search engine service may cause output information to be displayed on the computer monitor screen along with the navigation buddy so that it appears that the output information is being provided by the navigation buddy. The search engine service may be programmed to receive input information from a main user. The output information is based at least in part on the input information provided by the main user.

### CROSS REFERENCE TO RELATED APPLICATION(S)

The present application is a continuation in part of and claims the priority of U.S. patent application Ser. No. 11/309,086 filed on Jun. 19, 2006, applicant Andy Santana.

### FIELD OF THE INVENTION

This invention relates to improved methods and apparatus concerning Internet search engines.

### BACKGROUND OF THE INVENTION

There are various Internet search engines on the World Wide Web. Two well-known search engines are Yahoo (Trademarked) and Google (Trademarked). Generally, search engines share a common purpose. Typically that common purpose is to help online users find exactly what they are looking for efficiently. All search engines generally attempt to be efficient and accurate. Efficiency and accuracy help make a search engine popular and useful for users.

### SUMMARY OF THE INVENTION

The present invention, in one or more embodiments provides an apparatus comprising a computer processor, such as a server processor. The computer processor is programmed to provide a search engine service to one or more members. The computer processor or search engine service may be programmed to assist each member in accessing the Internet. The search engine service may cause a navigation buddy to be displayed on a computer monitor screen. The navigation buddy is typically a displayed character.

The search engine service may cause output information to be displayed on the computer monitor screen along with the navigation buddy so that it appears that the output information is being provided by the navigation buddy. The search engine service may be programmed to receive input information from a main user. The output information is based at least in part on the input information provided by the main user. The input information may include goal information, hobby information, or marital status information referring to the main user. The input information may include information about people other than the main user, wherein the people are known to the main user. The input information includes information about the main user's current mood. The output information may include information concerning one or more web sites.

The search engine service or computer processor may be programmed to allow a main user to prevent a dependent user from accessing the Internet from a main user computer.

The present invention also provides a method comprising causing a navigation buddy to be displayed on a computer monitor screen and causing output information to be displayed on the computer monitor screen along with the navigation buddy so that it appears that the output information is being provided by the navigation buddy.

The present invention in one or more embodiments provides a search engine or computer program running on a server processor, which will provide an all in one service that gives a user basic needs and more. The search engine, in one or more embodiments typically includes features that will allow a user to control more of the Internet and will give the user a different approach in what to search. The search engine, in one or more embodiments of the present invention will provide a goals section so that the user can get motivated when the user sees what the user wants to get accomplish in life. The goals section will be displayed on a user's personalized web page. The user's personalized web page will indicate web sites available for the user, in accordance with the user's interests and goals, and give suggestions to the user. The user's personalized web page, may in one or more embodiments, start off with an animated navigation buddy that may be displayed on the right side of at computer desktop page of a user computer. The search engine service, running on a server computer processor, may cause this navigation buddy to be displayed on a computer monitor screen or display when the user's computer is turned on. The navigation buddy will display various important user information such a Email, Reminder, Instant Message, and may display the names of new web sites located, which correspond to the user's interests or goals. Also the navigation buddy may appear to give suggestions on different web sites the user is viewing. For example, a list of web sites may be displayed on the computer monitor next to the navigation buddy, so that the navigation buddy appears to give the information. If the user is viewing a web page on different home cooked dishes and the user had looked at various web site pages regarding home cooked dishes and was not satisfied with the results, a suggestion button or field is displayed on the computer monitor. The suggestion button or field can be clicked on by the user to cause one or more web pages (suggestions) to be opened up. The one or more web pages or windows or names of web pages, may be displayed by the search engine computer program near the display of the navigation buddy, so that the navigation buddy appears to be providing the information. In the manner the navigation buddy will in effect, appear to provide the user with choices. The user can effectively, have a mini conversation with the navigation buddy. The search engine computer program may cause information to be displayed next to the navigation buddy so that the navigation buddy appears to be asking the user questions like, “How was your day?” and “What do you want to get accomplished today on the Web?. The search engine computer program may also cause motivational information to be displayed next to the navigation buddy, so that the navigation buddy appears to be trying to motivate the user. The motivation information may include motivating the user in what they want to get accomplished in life. The search engine computer program may also cause advice information to be displayed next to the navigation buddy so that the navigation buddy appears to give advice to the user. For example information may be displayed by the search engine so that the navigation buddy appears to ask the user, “How was your day?” and a list of field choices may appear such as “great”, “ok” and “not so great”. The user can click on one of these choices and the search engine computer program will respond to the choice by displaying appropriate web sites or web site names. For example, if the user clicks on “not so great” the search engine computer program may display web sites or web site names that are intended to cheer up the user. The web sites or web site names may be displayed next to the navigation buddy, so that it will appear that the navigation buddy is recommending the web sites to cheer up the user.

Generally, the search engine program will display information on the computer monitory display next to the navigation buddy and will display the navigation buddy in a manner, which will make it, appear that the navigation buddy is asking the user questions. Generally, the user will be able to click on a variety of responses. The search engine computer program will choose a web site page or web site pages to display on the user's personalized web page based on the user's choices. The search engine computer program will make it appear as if the navigation buddy decided what web site to display. The search engine computer program will allow a main or parent user to lock all internet access from a user computer and to unlock internet access by using a password. The search engine computer program will allow a main user to monitor a child or dependent user. The search engine computer program may provide or store a logbook or log data base of web sites that a child or dependent user have entered. If the child user or dependent user is viewing web site pages not for their age, the search engine computer program will display a warning on the user computer monitor display to the child or dependent user. The warning may specify that the user has a certain time limit, such as one minute, to close the web page. If the child or dependent user does not close the objectionable web site page within the time limit, the search engine computer program will boot the child or dependent user off of the web site and the user computer will lock internet access form the user computer until the main user views what the child or dependent user was viewing and the main user permits access by a password.

The present invention, in one or more embodiments provides a the spy viewing feature. This feature allows the main user, such as a parent user to control the time a child or dependent user spends online or on the internet. The spy viewing feature also allows the main or parent user to, view the dependent or child user's web browsing history, log off the child or dependent user from any home computer or network if the child is using the child's account or the main user's computer.

Also the main user can view on the user computer whatever the child or dependent user is viewing on the internet on any other computer as long as the child is using the child or dependent account number assigned by the parent or main user. The parent or main user can view what the child is doing in real time, i.e. see exactly what the child is viewing on the internet on the other computer at that moment, assuming the child has logged on using the child or dependent account number.

The search engine computer program may also display a link tab on the computer monitor display of the user computer. The purpose of the link tab is to let the parent acquire the child's web site viewing history list and to send it to the parent's e-mail account if the parent is not there to supervise the child.

This search engine computer program may remind the user by displaying of birthdays and anniversaries of friends, relatives, or business contacts. The search engine computer program may or display a vacation planner. The search engine computer program may suggest what present to get, what trip to go on, of what restaurant to take a person to for his or her birthday by causing such information to be displayed on a computer monitor display. The search engine computer program may suggest to spice up your relationship with a particular person. Also if the user is single the search engine computer program may suggest places where the user can meet single people as well activities to pick by displaying such information or web sites on the user computer monitory display.

The search engine computer program in accordance with the present invention may provide a profile for each person that is a subscriber to the search engine service. Each profile can be accessed by a subscriber to the search engine service. A user can choose not to have a profile on the search engine service. The profiles may aid in allowing a user to communicate with other subscribers to the search engine service.

The search engine service, in accordance with an embodiment of the present invention, may list or display on the user computer monitor display screen all or most of the countries in the world. The user can search for products or services in specific countries or states of countries. When the user gets their results the search engine computer program may display a map of the world on the top of a results web page. The search engine computer program may allow the user to click on a different country for the same product or service search and then the results for that search for the different country would be obtained.

If the user has clicked on a web site which has chain of businesses, the search engine computer program may cause all the business locations for that chain to appear or designated (such as by a plurality of stars on a world map so the user can view how many businesses the company haves and where they are all located.

The search engine computer program, in accordance with an embodiment of the present invention, may automatically provide a list of web site pages that have been updated that may coincide with a user's interests or goals. For example if the user is a big fan of hunting so the search engine computer program will always search for new web site pages and as well new updated information. After the search engine computer program locates an updated web site it may display the name of the updated web site or the updated web site page itself, or may generally alert the user concerning the update on the user's main personalized web page.

### BRIEF DESCRIPTION OF THE DRAWINGS

FIG. 1 shows a user computer for use in accordance with an embodiment of the present invention, wherein the user computer is connected to the internet and to a host computer;

FIG. 2 shows a first computer display image to be provided in accordance with an embodiment of the present invention;

FIG. 3 shows a second computer display image to be provided in accordance with an embodiment of the present invention;

FIG. 4 shows a third computer display image to be provided in accordance with an embodiment of the present invention;

FIG. 5 shows a fourth computer display image to be provided in accordance with an embodiment of the present invention;

FIG. 6 shows a fifth computer display image to be provided in accordance with an embodiment of the present invention;

FIG. 7A shows a sixth computer display image to be provided in accordance with an embodiment of the present invention;

FIG. 7B shows a seventh computer display image to be provided in accordance with an embodiment of the present invention;

FIG. 8 shows a eighth computer display image to be provided in accordance with an embodiment of the present invention;

FIG. 9 shows a ninth computer display image to be provided in accordance with an embodiment of the present invention;

FIG. 10 shows a tenth computer display image to be provided in accordance with an embodiment of the present invention;

FIG. 11 shows a eleventh computer display image to be provided in accordance with an embodiment of the present invention;

FIG. 12 shows an twelfth computer display image to be provided in accordance with an embodiment of the present invention;

FIG. 13 shows a thirteenth computer display image to be provided in accordance with an embodiment of the present invention;

FIG. 14 shows a fourteenth computer display image to be provided in accordance with an embodiment of the present invention;

FIG. 15 shows a fifteenth computer display image to be provided in accordance with an embodiment of the present invention;

FIG. 16 shows a sixteenth computer display image to be provided in accordance with an embodiment of the present invention;

FIG. 17 shows a seventeenth computer display image to be provided in accordance with an embodiment of the present invention;

FIG. 18 shows a eighteenth computer display image to be provided in accordance with an embodiment of the present invention; and

FIG. 19 shows a nineteenth computer display image to be provided in accordance with an embodiment of the present invention.

### DETAILED DESCRIPTION OF THE DRAWINGS

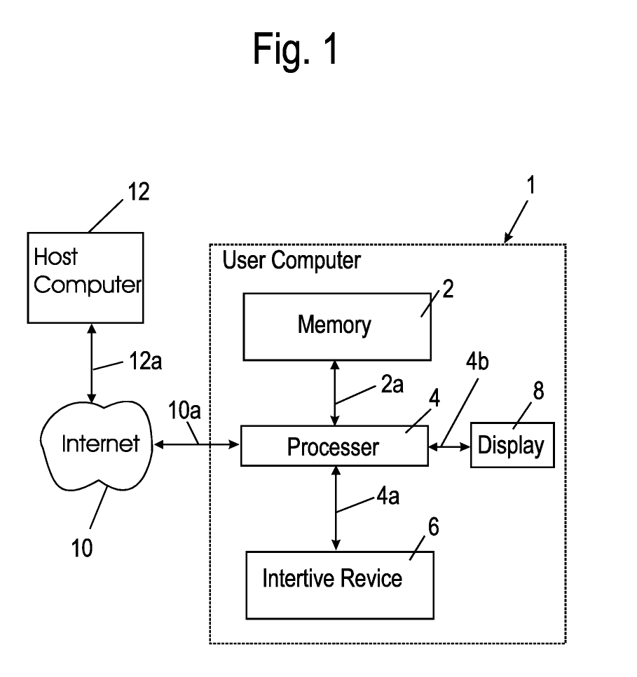

FIG. 1 shows a user computer 1 for use in accordance with an embodiment of the present invention. The user computer 1 is connected by a communications link 10a to the internet 10. A host computer 12 is shown connected by a communications link 12a to the internet 10.

The user computer 1 includes a memory 2, a processor 4, an interactive device 6, and a display 8. The memory 2, the interactive device 6, and the display 8 are connected by communications links 2a, 4a, and 4B, respectively, to the processor 4. The communications links 2a, 4a, and 4B, may be any type of communications links such as hardwired, wireless, or fiber optic and allow the communication of electronic or computer data. The processor 4 typically may be any type of computer processor. The interactive device 6 may a keyboard or a computer mouse or any other type of interactive device or combination of interactive devices. The display 8 may be a computer monitor. The memory 2 may be any type of computer memory.

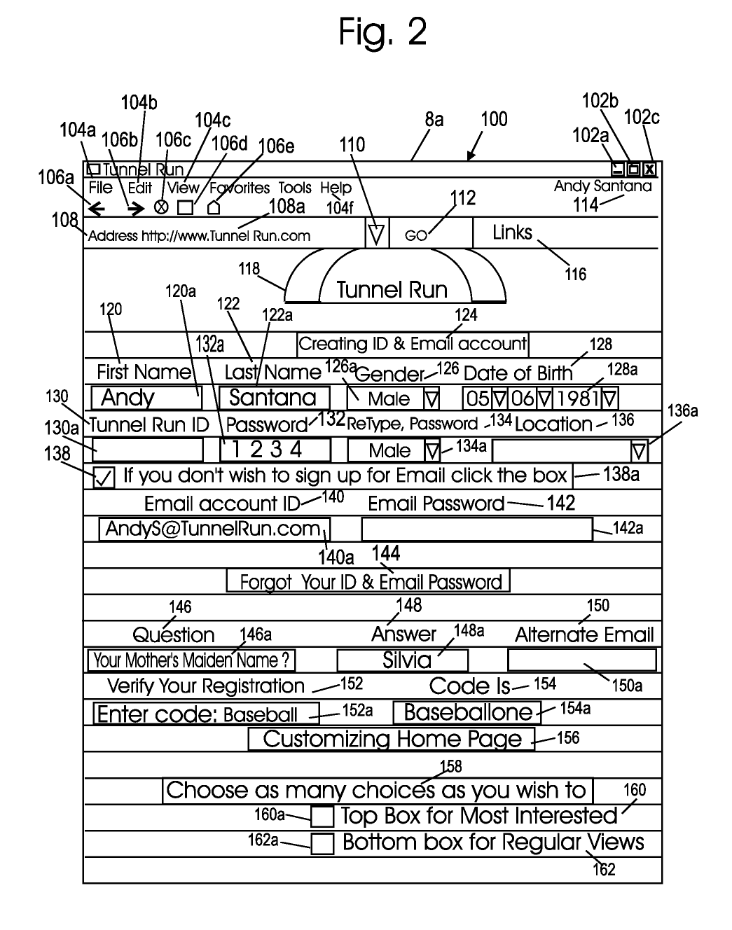

FIG. 2 shows a first computer display image 100 on the screen 8a of the display 8 to be provided in accordance with an embodiment of the present invention. The processor 4 may cause the image 100 to appear on the screen 8a of the display 8 when a user types in www.tunnelrun.com (the example name for the search engine for an embodiment of the present invention).

The image 100 includes a symbol 102a which when clicked on causes the image 100 to be minimized. The image 100 includes a symbol 102b which when clicked on causes the image 100 to be maximized. The image 100 includes a symbol 102c which when clicked on causes the processor 4 to close the application program displaying the image 100 and causes the processor 4 to remove the image 100 from the screen 8a of the display 8.

The image 100 also includes a designation 104a for “File”, a designation 104b for “Edit”, a designation 104c for “View”, a designation 104d for “Favorites”, a designation 104e for “Tools”, and a designation 104f for “Help. Clicking on one of the designations 104a-f may cause a drop down menu to be displayed similar to the drop down menus displayed in the Word (trademarked) word processor computer program as known in the art.

The image 100 includes a designation 101 for “Tunnel Run” this may be the name of the search engine running on the processor 4 or another processor, such as a server, in accordance with the present invention.

The image 100 also includes a back arrow 106a and a forward arrow 106b. Clicking on the back arrow 106a will typically cause the last previously displayed internet web page to be displayed again, unless the current internet web page is the only page viewed this session, in which case the same internet page would remain displayed on screen 8a of display 8. Clicking on the forward arrow 106b may cause a forward web page to be viewed (i.e. after clicking on the back arrow 106 to go from web page A to a previously viewed web page B, the user can go forward to the web page A). The designation 106c, when clicked on closes the image or web page 100 so that it is no longer displayed on screen 8 of display 8. The designation 106d, which is a square box, when clicked on refreshes or updates the web page or image 100.

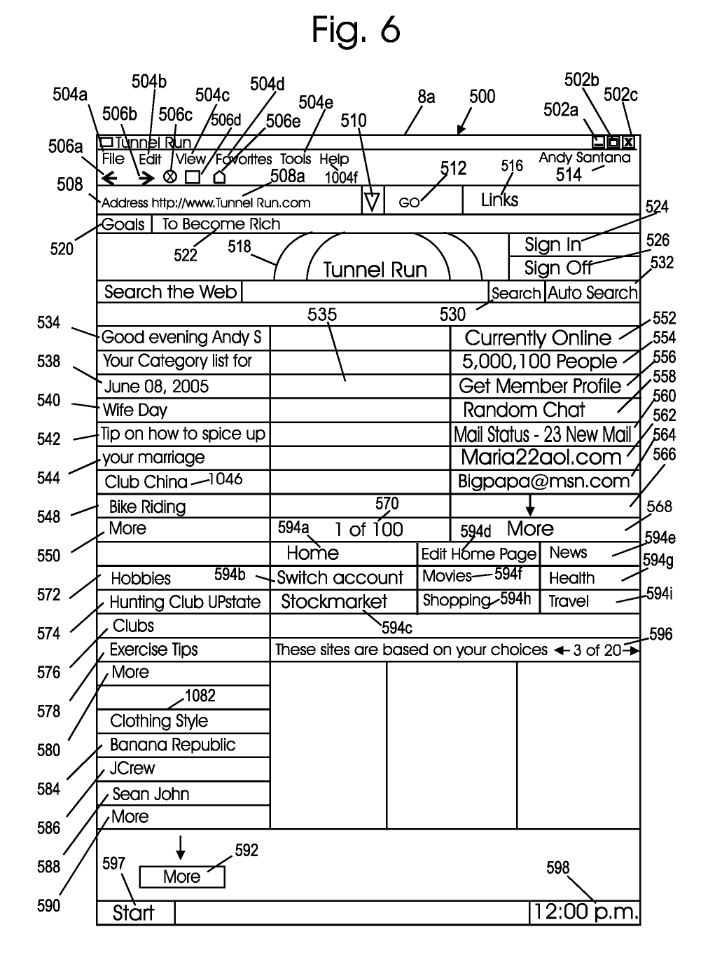

The designation or five-sided FIG. 106, when clicked on causes a home web page or image, as in FIG. 6 instead of image 100.

The fields 102a-c, 104a-f, and 106a-e may be part of standard features which are provided by INTERNET EXPLORER (trademarked) computer software and/or other known computer software.

The image 100 also includes a designation 114 for “Andy Santana” which may be the name of the person that the user computer 1 belongs to. Designations of 108 and 108a for “Address” and “www.tunnelrun.com” , respectively, Indicate an internet address for accessing the search engine in accordance with an embodiment of the present invention.

The image 100 also includes a designation 110 of an upside down triangle which when clicked on, causes the screen 8a to display a list of all the web pages the user has visited during this session, i.e. from the time the user most recently logged in to the present. The image 100 also includes a designation 112 for “GO” which when clicked on causes a home page for the internet address shown in the designation 108a to appear on the screen 8a of the display 8.

The image 100 also includes designations or fields 116, 118, 120, 122, 124, 126, 128, 130, 132, 134, 136, 138, 140, 142, 144, 146, 148, 150, 152, 154, 156, 158, 160, and 162.

Field 118 shows a logo and name that is displayed for the search engine web site, which is shown as “Tunnel Run” and logo. Designations 120, 122, 126, 128, 130, 132, 134, 136, 138, 140, and 142 identify information for creating an identification and e-mail account for accessing the search engine in accordance with the present invention. Fields 120a, 122a, 124a, 126a, 128a, 130a, 132a, 134a, 136a, 140a, and 142a show information which has been typed in by a user through interactive device 6 of FIG. 1 or show a blank space meaning no information has been typed in for that particular designation.

When a check mark is entered in field 138a, the user indicates that he does not want to sign up for e-mail sent the owners of the www.tunnelrun.com web site and/or search engine. If an e-mail account is desired, then the user can enter their e-mail address in field 740a under designation 140. When the user puts in his or her new e-mail address, the search engine service in accordance with an embodiment of the present invention, will send all the information to the new e-mail created. If a different password on the email account for the user is desired, the user can enter the Email password in the field 142a.

Field 144 can be clicked on when a user forgets their identification information or password. The user will be sent their identification and e-mail password by e-mail by the search engine computer program after the user enters information for a question and an answer in fields 146a and 148a.

Designations 150, 152, 154, 156, 158, 160, and 162 identify or provide explanation regarding further information which can be entered by a user through interactive device 6 of FIG. 1. Fields 146a, 148a, 150a, 152a, 154a, 160a, and 162a show information which has been typed in by a user through interactive device 6 of FIG. 1 or show a blank space meaning no information has been typed in for that particular designation.

A search engine (or processor running a software program search engine) in accordance with the present invention, requests or allows entry of information as shown in FIG. 2, in order to display web pages or information personalized to an operator of user computer 1.

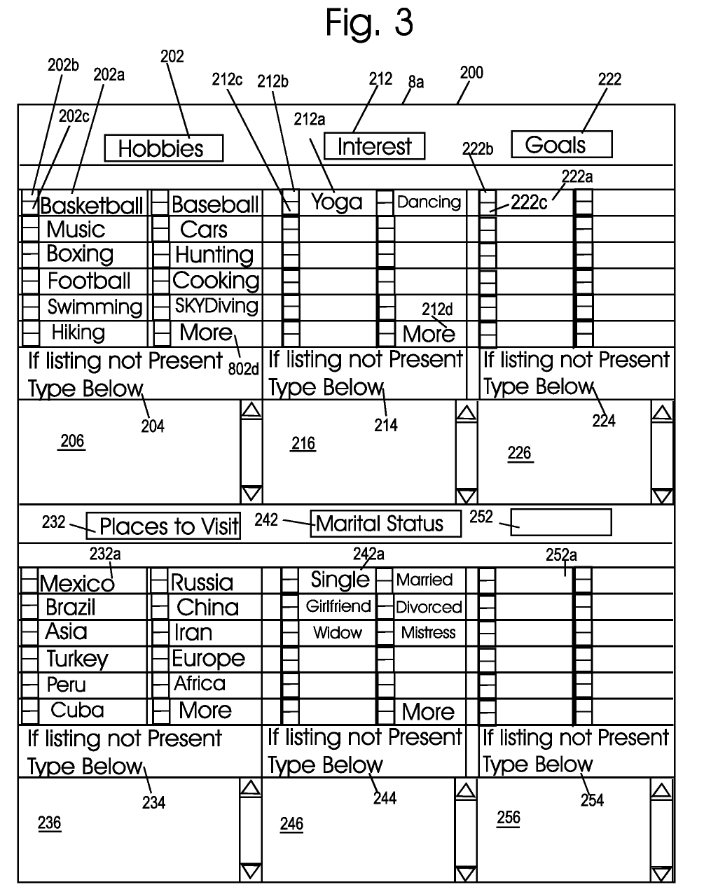

FIG. 3 shows an second computer display image 200 on the screen 8a of the display 8 to be provided in accordance with an embodiment of the present invention. The image 200 may be part of a home page for the web site www.tunnelrun.com. The image 200 may appear after the image 100 when the user scrolls down using interactive device 6.

The image 200 includes designations or fields 202, 212, and 222. Under these fields or designations, one or more choices for hobbies, interests, and goals, respectively, may appear. For example, under the designation of hobbies 202, appears the designation or choice 202a for “Basketball” under the designation of interest appears the designation or choice 212a for “Yoga” and under “Goals there is a blank choice 222a. There are two box fields next to each hobby, interest, and goal, such as box fields 202b and 202c for hobbies, 212b and 212c for interests, and 222b and 222c for goals. Clicking (with a computer mouse of interactive device 6) on the top box field, such as box 202b, selects the appropriate hobby, interest, or goal, while clicking on the bottom box field, such as box 202c undoes the selection of the particular hobby, interest or goal. The hobby, interest, and goal information is entered by a user of user computer 1, so that the search engine web site will have more information about the individual so that it can service the individual's needs in a better manner. Although not shown in FIG. 3, typically for the field 822 “Goals” there would be a listing of goals for the user. For example, a goal in field 822a or similarly shown fields may be “Becoming a teacher” or “Becoming a Boxer”. The search engine in accordance the present invention, takes the information concerning the individual's goals and displays on screen 8 shown in FIG. 6 web sites that can improve the individual's skills to reach that goal (such as to become a teacher).

Designations 204, 214, and 224 and corresponding entry fields 206, 216, and 226 respectively, allow an operator to enter via interactive device 6, further hobbies, interests or goals respectively, if not listed under designations 202, 212, and 222.

The image 200 includes designations or fields 232, 242, and 252 referring to places to visit, marital status, and a blank space. A plurality of choices appears under each of fields 232 and 242, such as designation or field 232a for “Mexico” and designation 242a for “Single”. Each choice has a box field next it for selecting or undoing a selection. Further choices can be entered by a user in fields 236, 246, and 256 under designations 234, 244, and 254.

If a user puts “single” in the designation 242a as shown in FIG. 3, then the processor 4 or server process will display web sites in image of FIG. 6 in the columns underneath field 596. If the user puts “single” in field 242a then field 540 in FIG. 6 will change. The web sites that the search engine service will look for will depend on what is placed in fields of FIG. 3, such as field 242a.

A user can enter information into fields 202, 212, 222, 232, 242, 252 so that the search engine service can know what the user is interested in and can display web sites related to such information, such as through image or web page 500 of FIG. 6.

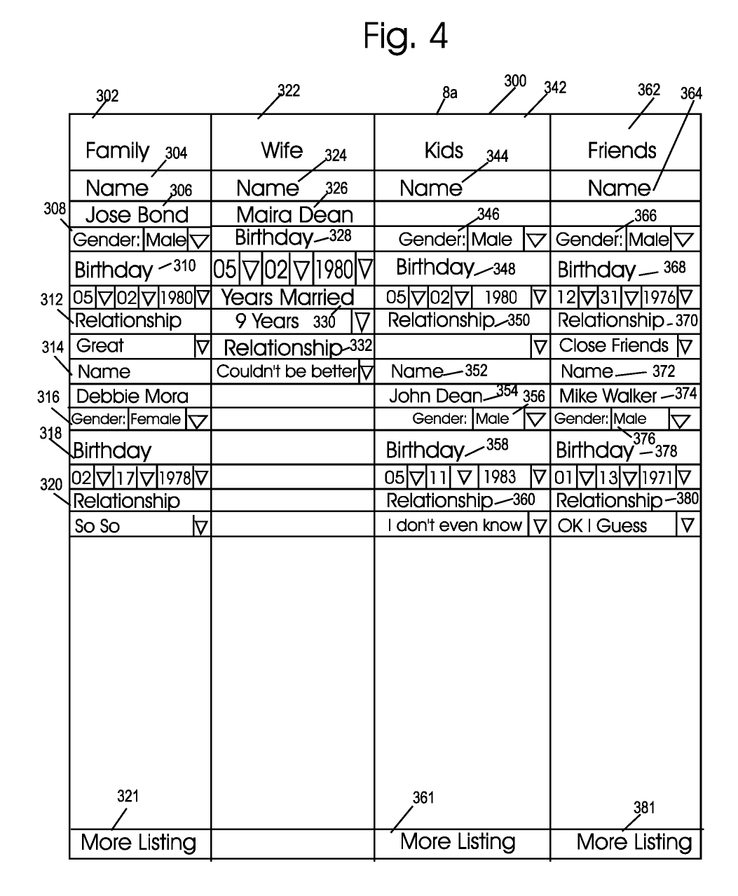

FIG. 4 shows a third computer display image 300 on the screen 8a of the display 8 to be provided in accordance with an embodiment of the present invention. The image 300 includes fields 302, 304, 306, 308, 310, 312, 314, 316, 318, 320, 321, 322, 324, 326, 328, 330, 332, 342, 344, 346, 348, 350, 352, 354, 356, 358, 360, 361, 362, 364, 366, 368, 370, 372, 374, 376, 378, 380, and 381.

The column of fields headed by field 302 deals with information regarding a user's family. Fields 302 and 304 are headings. A user can enter a family member's name, such as “Jose Bond” into field 306. Field 308 includes a fixed heading for “Gender” and a scroll arrow for choosing between “Male” and “Female”. In FIG. 4, “Male” has been selected. Field 310 includes a fixed heading for “Birthday”, and three scroll arrows for choosing a month, day, and year respectively, for a birthday of the individual entered in field 306. In FIG. 4, the birthday of May 02, 1980 has been selected. Field 312 includes a fixed heading for “Relationship” and a scroll arrow for choosing a word or phrase that describes the relationship between the user and the individual shown in field 306. In FIG. 4, the word “Great” has been selected.

Field 314 includes a fixed heading for “Name” and the name “Debbie Mora”, which is another individual that is a member of the user's family. Field 316 is similar to field 308 and includes a fixed heading for “Gender” and a scroll arrow for choosing between “Male” and “Female”. In FIG. 4, “Female” has been selected for field 316. Field 318 includes a fixed heading for “Birthday”, and three scroll arrows for choosing a month, day, and year respectively, for a birthday of the individual entered in field 314. In FIG. 4, the birthday of Feb. 17, 1978 has been selected. Field 320 includes a fixed heading for “Relationship” and a scroll arrow for choosing a word or phrase that describes the relationship between the user and the individual shown in field 314. In field 320 of FIG. 4, the phrase “So So” has been selected. Field 321 when clicked on causes more or different family members to be listed in the column of family field 302.

The column of fields headed by field 322 deals with information regarding a user's wife. Fields 322 and 324 are fixed headings. Field 326 is a name for the user's wife which can be entered in field 326 by the user. Field 328 is similar to field 310 under the “family” column. Field 328 includes a fixed “Birthday” heading and three scroll arrows for selecting a month, day and year, respectively, of the wife's birthday. Field 330 includes a fixed heading for “Years Married” and a scroll arrow for scrolling through and selecting a number of years married. In FIG. 4, “9 Years” has been selected. Field 332 includes a fixed heading for “Relationship” and a scroll arrow for scrolling through and selecting a word or phrase that describes the user's relationship with his wife. In FIG. 4, “Couldn't be better”]has been selected.

The column of fields headed by field 342 deals with information regarding a user's children or kids. Fields 342 and 344 are fixed headings. Field 346 is similar to field 308. Field 348 is similar to field 310. Field 350 is similar to field 312. Field 352 shows a fixed heading for “Name”. Field 354 shows the entered name of “John Dean”. Field 356 is similar to field 316. Field 360 is similar to field 320. Field 361 when clicked on allows more or different kids to be added in the column of “kids” field 302, with appropriate information.

The column of fields headed by field 362 deals with information regarding a user's friends. Fields 362 and 364 are fixed headings. Fields 366, 368, 370, 372. 374, 376, 378, and 380 are similar to fields 346, 348, 350, 352, 354, 356, 358, and 360. Field 381 when clicked on allows more or different kids to be added to the list of kids that the search engine service has information regarding and which can be shown in the column of “kids” field 302, with appropriate information.

A user can enter information regarding family, wife, kids, and friends into the image 300 the processor 4 or a server processor will use the information entered to remind the user of dates, such as birthdays of friends and relatives. The processor 4 or server processor also may suggest to the user of possible presents to get the appropriate family member or friend. The levels of relationship or words describing relationship, which the user can select, may include three levels such as “Great”, “So So”, and “Awful”. The search engine service in accordance with the present invention, running on the processor 4 or server processor, may suggest counselling web sites depending on the level of relationship or may suggest certain types of gifts depending on level of relationship.

For the “Kids” relationship field 360, a user can select between “They love me”, “Sometimes”, or “I don't even know”. Other phrases or indications of relationship level may be provided. The search engine service may recommend web sites for a user/parent to improve their relationship with their child. For the “Friends” relationship field 380, a user can select between “Close Friends”, “From time to time”, or “OK I guess”. These relationship indications provide information to the search engine service which it uses to provide appropriate suggestions for gifts.

Information entered in field 330 by the user can be used by the search engine service to recommend certain actives to married couples depending on how long they have been married. It may provide suggestions to newlyweds on how to keep marriage going. The levels of relationship or phrases which can be entered in field 332 may include “couldn't be better”, “it gets rocky from time to time”, or “almost at the end”. Based on the answer, the search engine service can recommend web sites based on the state of the relationship.

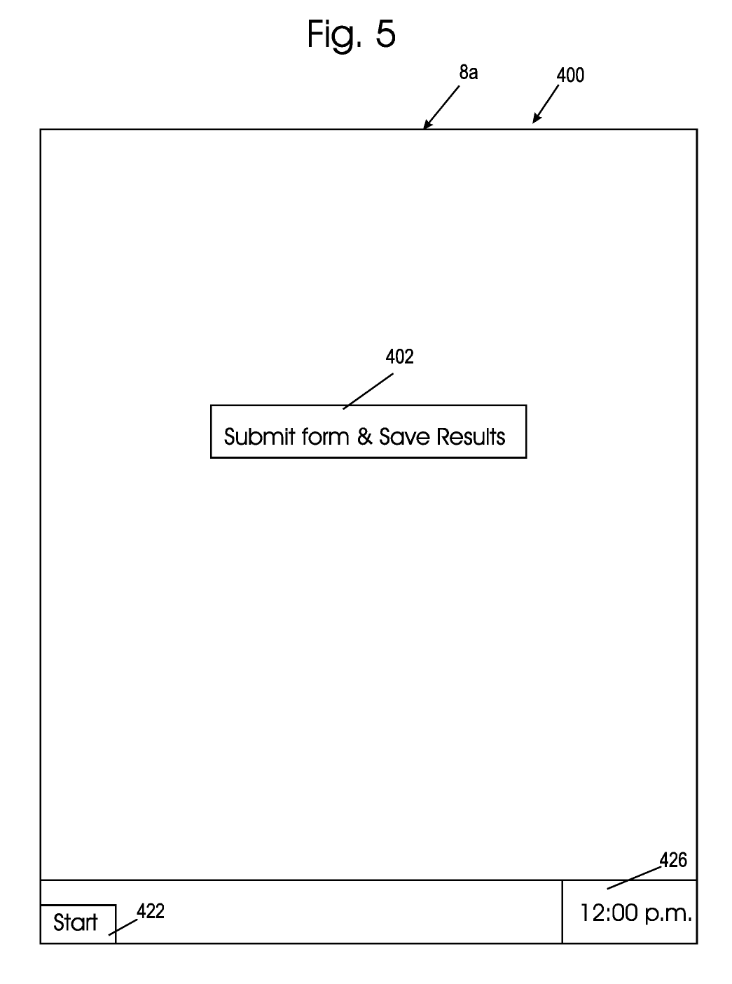

FIG. 5 shows a fourth computer display image 400 on the screen 8a of the display 8 to be provided in accordance with an embodiment of the present invention. The image 400 may be part of a home page for the web site www.tunnelrun.com. The image 400 may appear after the image 200 when the user scrolls down using interactive device 6. The image 400 includes the field 402 which can be clicked on by a user using interactive device 6, to submit the information that user entered in FIGS. 2 and 3 to the processor running the search engine in accordance with the present invention. Clicking on field 402 also causes the information in FIG. 6 to be displayed. The image 400 may be displayed on a desktop page which may show a start designation 422 at the bottom left corner and a time designation 426 (“12:00 p.m. ”) at the bottom right corner.

FIG. 6 shows a fifth computer display image 500 on the screen 8a of the display 8 to be provided in accordance with an embodiment of the present invention. The processor 4 may cause the image 500 to appear on the screen 8a of the display 8 when a user types in www.tunnelrun.com (the example name for the search engine for an embodiment of the present invention) assuming the user has entered identification information in image 100 of FIG. 2. The image 500 is the main home page starting point for the search engine in accordance with an embodiment of the present invention.

The image 500 includes symbols or designations 502a, 502b, 502c, 504a, 504b, 504c, 504d, 504e, 504f, 506a, 506b, 506c, 506d, 506e, 508, 508a, 510, 512, and 514 and 518 similar to symbols or designations 102a, 102b, 102c, 104a, 104b, 104c, 104d, 104e, 104f, 106a, 106b, 106c, 106d, 106e, 108, 108a, 110, 112, and 114 and 118.

The image 500 includes designations 520 and 522 which indicate a goal to motivate the user which may have been chosen by the user from image 200 of FIG. 3 under the designation goals 222 (No goals are currently shown in FIG. 3, however, typically various choices for goals would be shown).

The image 500 includes fields 524 and 526 which can be clicked on to sign in or sign off, respectively, from the search engine web site or from the individual's customized web page in shown in image 500. The image includes designations or fields 530 and 532 which when clicked on allow the user to search the internet for information. The field 532 for auto search, allows the user to tell the search engine to automatically display different web sites. A field 534 is provided which displays the user name and greets the user, with a greeting that is dependent on the time of day. A window 535 is provided in image 500. The window 535 may display pictures, different webs sites, sponsor web sites, and may show different web sites that have been selected based on the user's choices in FIGS. 2 and 2.

The image 500 includes fields 552 and 554 which indicate how many user are on the web site for the search engine, i.e. www.tunnelrun.com. The image 500 further includes field 556 which can be clicked on by the user if the user wants to locate a member profile located in the search engine www.tunnelrun.com service.

A field 558 is provided that a user can click on if they want to chat with anyone within the service, i.e. anyone that subscribes to the www.tunnelrun.com search engine service.

Fields 560, 562, 564, 566, and 568 displays the people that emailed the user and lists each person's email address so the user can see whether the emails are important. Also the user can click on a particular user name and view only their email, such as by clicking on field 562 for “Maria22aol.com”. If the user wants to view all the email sent to the user, then the user can click on the field 562, the mail status section, to view all the emails.

A field 596 with three columns underneath is shown for image 500. The three columns will typically display different web sites that the user can pick from a choices list on FIG. 3 and one or more web sites that the search engine service suggests to present to the user. There may be a picture in each of the three empty columns underneath field 596, where each picture can be clicked on to take someone to a particular web site. The search engine computer software running on the server processor or processor 4 will typically display different web sites each day in field 596. The web sites presented in field 596 will typically be based on what the user entered in FIGS. 2 and 3.

Image 500 also includes fields 536, 538, 540, 542, 544, 546, 548, 550, 572, 574, 576, 578, 580, 584, 586, 588, and 590, which present information based on what the user choose or entered in the images 100 or 200 of FIGS. 2 and 3. This will display the choices the user picked and may also remind the user of people's birthdays, anniversaries, vacation planner, restaurant, and what to give for the user's friends, family or birthday.

Each of the fields 536, 538, 540, 542, 544, 546, 548, 550, 572, 574, 576, 578, 580, 584, 586, 588, and 590 can be clicked on to obtain suggestions from the search engine. Such suggestions may include providing web sites for buying a present, for planning a night out, and for recommending places that single people can meet. Typically the search engine will automatically new update information to present the user.

Fields 590 or 592, when clicked on allows the user to access further information and choices. Field 594a, when clicked on, allows the user to edit the home page i.e. the image 500 shown in FIG. 6. Field 594b, when clicked on, causes an image for another account for the search engine service to be switched to or displayed on screen 8a of the display 8. Field 594c, when clicked on, causes a stock market web site page to be displayed on screen 8a of the display 8. Similarly fields 594d, 594e, 594f, 594g, 594h, and 594i, when clicked on may cause web site pages to be displayed on screen 8a of display 8 showing the information appropriate to the designations. The image 500 also shows start field 597 and a time designation 598.

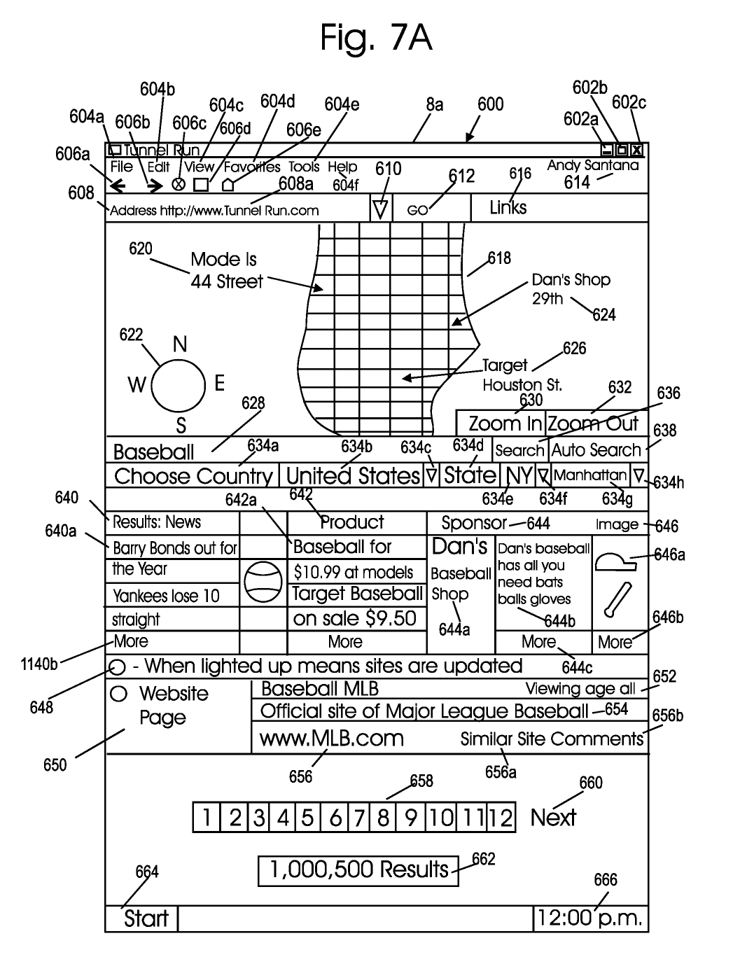

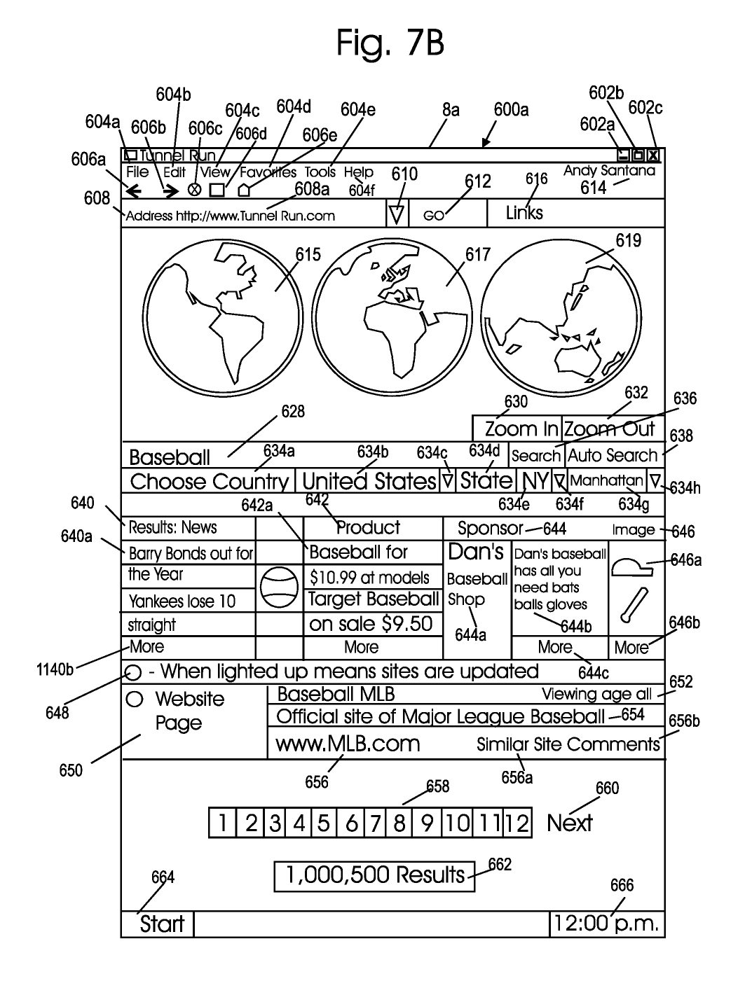

FIG. 7A shows a sixth computer display image 600 on the screen 8a of the display 8 to be provided in accordance with an embodiment of the present invention. The processor 4 may cause the image 600 to appear on the screen 8a of the display 8 when a user clicks on field 530 in image 500 of FIG. 6 for “search”. The user would put information that the user wants searched in field 628 of image 600.

The image 600 includes symbols or designations 602a, 602b, 602c, 604a, 604b, 604c, 604d, 604e, 604f, 606a, 606b, 606c, 606d, 606e, 608, 608a, 610, 612, 614 and 616 similar to symbols or designations 102a, 102b, 102c, 104a, 104b, 104c, 104d, 104e, 104f, 106a, 106b, 106c, 106d, 106e, 108, 108a, 110, 112, and 114 and 116.

The image 600 includes a map 618 of a particular geographic area such as an area of a city. Designations 620, 624 and 626 indicate locations for a chain of businesses on the map 618. Designation 622 indicates north, south, east and west directions for the map 618. Designations or fields 630 and 632 can be clicked on to zoom in our zoom out on the map 618 to get a close-up view of the area or to get a view of a larger area surrounding the area shown by map 618.

An operator can type a term such as “baseball” into the field 628 (via the interactive device 6, and then click on field 636 to search the internet for the term “baseball. The user can click on the field 638. Field 638 when clicked on causes a random web site to be opened so the user can view it. The sites that will open randomly are based on the user's choices on FIG. 3.

Upside down triangle or field 634c can be clicked on to allow a user to scroll through a list or otherwise choose a country that map 618 will refer to. In this case the United States has been chosen as shown by the information in field 634b next to field 634a. Upside down triangle or field 634f can be clicked on to allow a user to scroll through a list or otherwise choose a state that map 618 will refer to. In this case the state of NY or New York has been chosen as shown by the field 634e next to field 634d. Upside down triangle or field 634h can be clicked on to allow a user to scroll down through a list or otherwise choose a city or area that map 618 will refer to. In this case the borough of Manhattan has been selected as indicated by field 634g.

Fields 640, 642, 644, and 646 are headings. Fields 640a, 642a, 644a-b, and 646a provide information concerning what the user typed in field 628 to search on, in this case “Baseball”. Field 640 is a news heading. Field 640a provides news about baseball and field 640b, when clicked on causes different news about baseball to be displayed in field 640a. Field 642 is a news heading. Field 642a provide product information about baseball related products. Field 642b when clicked on causes different information about products related to baseball to be displayed in field 642a. Fields 644 is a sponsor heading. Fields 644a-b provide information relating to a particular sponsor. Field 644c when clicked on causes different sponsorship information to be displayed in fields 644a and 644b. Field 646 is an image heading. Field 646a displays images, in this case a baseball cap and glove, about the particular products available regarding the “Baseball” search topic. Field 646b when clicked on causes different images about baseball to appear in field 646a.

Clicking on the “More” fields 640b, 642b, 644c, and 646b may also take the user to another web page for more details about news, products, sponsors, or images, respectively.

The image 600 includes field 648 which when lit up indicates that various web sites have been updated which the user wanted to view. The search engine service will know if there have been any changes because it will have a day and month when the main user for the web site updated their web site. A field 650 has a circular area which is lit up when the web site the user wants to view has been updated. A field 652 displays a generic name for a web site or sponsor of a web site and what the viewing age for the web site is. In this case the viewing age is “viewing age all”. A field 654 explains further what the web site is for. A field 656 is provided which identifies the web site address. Field 656a clicked be clicked on by a user to display similar web sites on the screen 8a. Field 656b can be clicked on to display a comments section where the operator can enter comments onto the screen 8a via interactive device 6.

A field 658 displays a number of results pages for a user's search. Clicking on a number of the field 658 causes a specific results web page to be displayed on the screen 8a of the display 8. A field 662 indicates the number of result web sites or web pages for the search term searched, which in this case was “Baseball” shown in field 628.

FIG. 7B shows a seventh computer display image 600a on the screen 8a of the display 8 to be provided in accordance with an embodiment of the present invention. The processor 4 may cause the image 600a to appear on the screen 8a of the display 8 when FIG. 6, field 530 is used. The image 600a is the same as the image 600 in FIG. 7A, except that the images 615, 617, and 619 showing parts of a world map are shown in FIG. 7B, while images 618, 620, 622, 624, and 626 concerning a detailed map of a particular section of a city are shown in FIG. 7A. The image 600a is shown when the zoom out image 632 is clicked on and the image 600 is shown when the zoom in image 630 is clicked on.

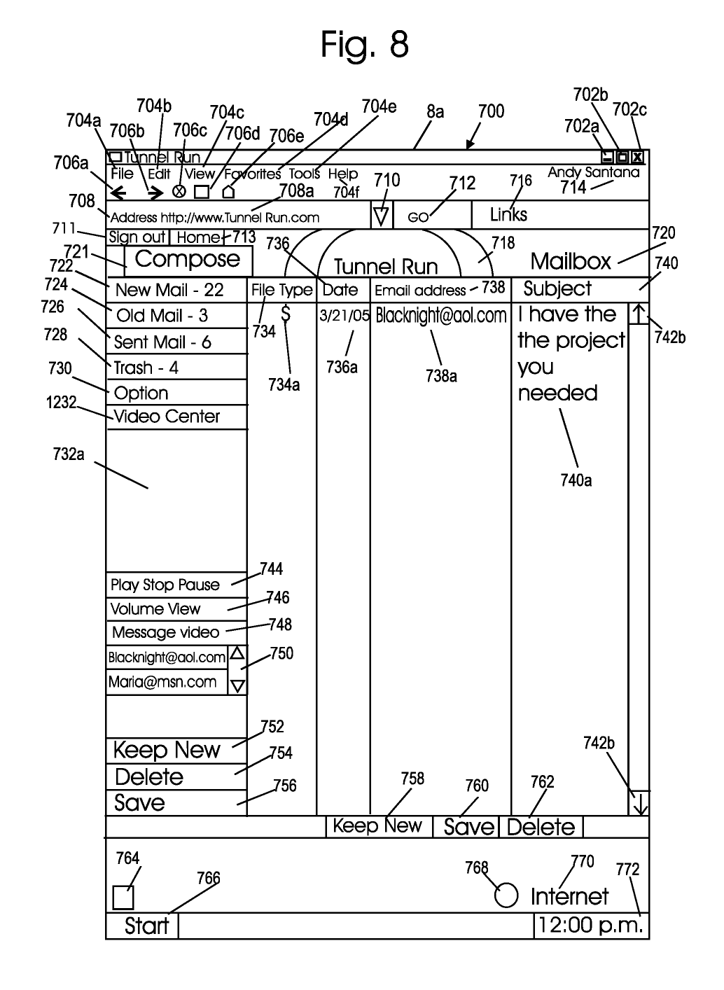

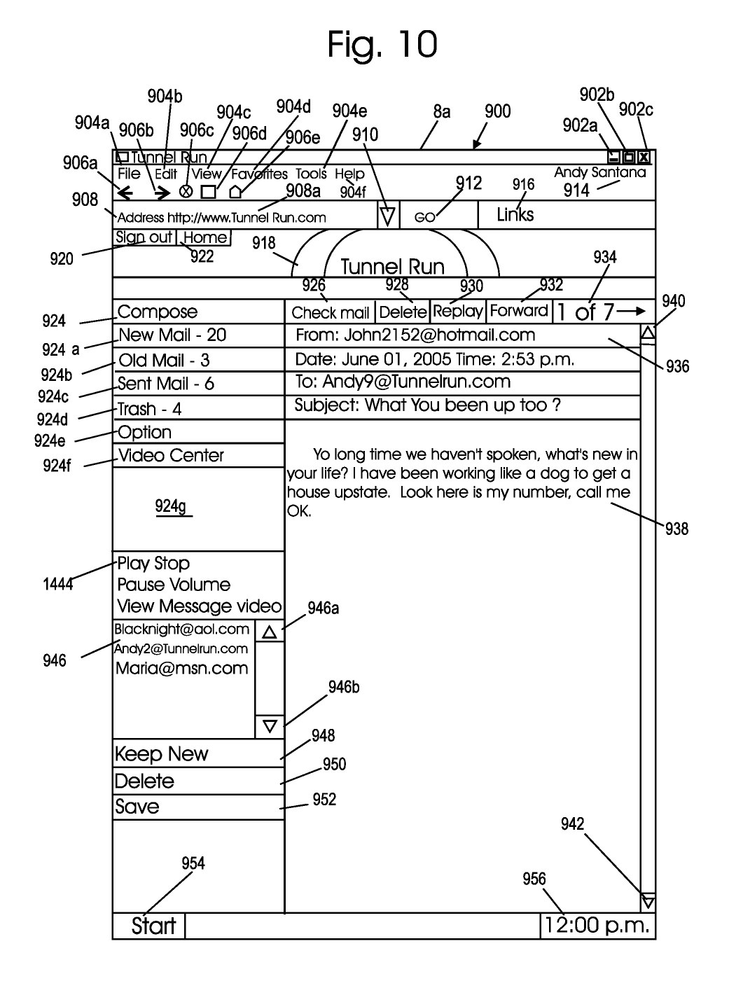

FIG. 8 shows a seventh computer display image 700 on the screen 8a of the display 8 to be provided in accordance with an embodiment of the present invention. The processor 4 may cause the image 700 to appear on the screen 8a of the display 8 when a user clicks on field 516 for “Links” in FIG. 6. The image 700 may include a sign out field 711 and a home field 713 similar to fields 920 and 922 shown for image 900 and to be described with reference to FIG. 10.

The image 700 includes symbols or designations 702a, 702b, 702c, 704a, 704b, 704c, 704d, 704e, 704f, 706a, 706b, 706c, 706d, 706e, 708, 708a, 710, 712, 714, 716, and 718 similar to symbols or designations 102a, 102b, 102c, 104a, 104b, 104c, 104d, 104e, 104f, 106a, 106b, 106c, 106d, 106e, 108, 108a, 110, 112, 114, 116, and 118.

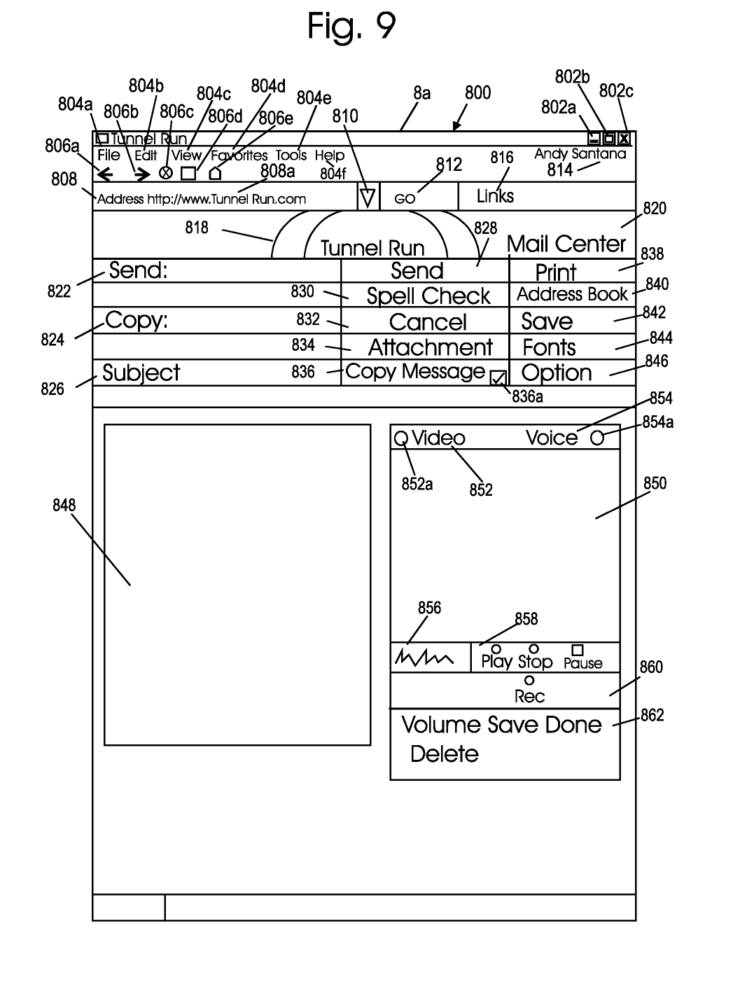

The image 700 includes field 719 which is heading. The image 700 includes field 721 “Compose” which when clicked on causes the display of image 800 in FIG. 9. The image 700 includes fields 722, 724, 726, and 728 which indicate the number of new, old, sent, and trashed e-mails for a user. Each of fields 722, 724, 726, and 728 can be looked at to view e-mails new, old, sent or trashed, respectively. The image 700 I includes field 730 which when clicked on allows a user to indicate a length of time that a user wants to have an e-mail stored on memory of a server computer of the search engine in accordance with the present invention.

Field 732 is a heading for a video center. Field 744 allows an operator to play, stop, or pause (by clicking on play, stop, or pause) a video message in field 732a. The video message may be left by another user on the same search engine service. Field 746 can be clicked to control volume or to view the video message (by clicking on the volume or the view designations). A video from an e-mail may be displayed in field 732a when one of the e-mails from field 750 is clicked on. The e-mails can be scrolled through by clicking on the up down triangles or arrows in field 750. Field 752 when clicked on allows a video message to be saved or kept for a while. Field 754 when clicked on deletes a video message. Field 756 when clicked on saves a video message.

Fields 734, 736, 738, and 740 refer to headings for an e-mail to be sent to another user of the search engine service. Fields, 734a, 736a, 738a, and 740a show a file type, a date, an e-mail address, and a subject for an e-mail to send to a user. Fields 742a and 742b are scroll down arrows to display other e-mails or messages. For example there may be more e-mails then fit on the screen 8a, and the user can scroll up or down using fields 742a and 742b to view other e-mail. When sections 734a, 736a, 738a, 740a, in FIG. 8, has been opened, it will take you to image 900 shown in FIG. 10. Once image 900 is closed, fields 734a, 736a, 738a, and 740a turns red. Once the user closes image 700, the e-mail that the user opened will no longer be displayed on the screen 8a. However, But once the user clicks on the field 758, then the e-mail it will stay in fields 734a, 736a, 738a, and 740a. To use field 760 in order to, delete an e-mail message, the user would clicks on field 734a, 736a, 738a, and 740a. The individual who sent the user the e-mail in fields 734a, 736a, 738a, or 740a will be highlighted. When the user clicks on field 760, then e-mail is deleted. For the save section button, field 762, the user clicks on fields 734a, 736a, 738a, and 740a, for the e-mail you want saved in field 762. Once fields 734a, 736a, 738a. 740a , are highlighted then the user can click on field 762, to save to memory of the user computer hard drive. Field 766 is a start field which typically appears at the bottom left hand corner of desktop page. Field 768 does what. Field 770 refers to the internet. Field 772 show the current time.

FIG. 9 shows a eighth computer display image 800 on the screen 8a of the display 8 to be provided in accordance with an embodiment of the present invention. The processor 4 may cause the image 800 to appear on the screen 8a of the display 8 when a user clicks on field 721 “Compose” in FIG. 8

The image 800 includes symbols or designations 802a, 802b, 802c, 804a, 804b, 804c, 804d, 804e, 804f, 806a, 806b, 806c, 806d, 806e, 808, 808a, 810, 812, 814, 816, and 818 similar to symbols or designations 102a, 102b, 102c, 104a, 104b, 104c, 104d, 104e, 104f, 106a, 106b, 106c, 106d, 106e, 108, 108a, 110, 112, 114, 116, and 118.

The image 800 includes a designation 820 which indicates that this web page is the mail or e-mail center. The image 800 also includes designations 822, 824, and 826 each of which are next to open fields in which a user can enter an e-mail address to send information to (next to fields 822 and 824), and a subject of the e-mail (next to field 826). The actual content of the e-mail can be typed in field or box 848. Field 828 when clicked on sends the e-mail whose content will be typed in field 848. Field 830 when clicked on spell checks the e-mail of field 848 or attached files. Field 832 “Cancel” when clicked on clears everything that the user had filled in under headings in fields 822, 824, 826, 848, and 850. Field 834 when clicked on allows a user to attach an attachment to an e-mail to be sent. Field 838 when clicked on prints the e-mail referred to in field 848. Field 840 when clicked on displays an address book. Field 842 when clicked on saves the e-mail just typed in field 848. Field 844 when clicked on displays a choice of fonts for the e-mail in field 848. Field 846 when clicked on may cause a list of options to be displayed, such as how many days the user wants to keep old e-mail, whether the user wants to auto save all e-mail to a hard drive, or whether a user wants to black e-mail from another user.

Fields 852, 852a, 854, 854a, 850, 856, 858, 860, and 862 refer to allowing the user to record their voice or a video image and to send it with the e-mail referred to in field 848. Field 852a next to designation 852, is lit or highlighted when a video is being recorded. Field 854a next to designation 854 is lit or highlighted when a video is being recorded. Field 850 displays a video or camera image while it is being recorded. Field 856 shows a sound signal amplitude. Appropriate designations in field 858 can be clicked on to play, stop, or pause the recording. Field 860 can be clicked on the record the video or sound recording. Appropriate designations in field 862 to be used to control the volume, save the recording, indicate the recording is done, or delete the recording. When the operator is finished recording voice or video, clicking on the “Done” designation in field 862 and will cause the processor 4 or a server processor to attach the video or recording to the email to be sent.

FIG. 10 shows a ninth computer display image 900 on the screen 8a of the display 8 to be provided in accordance with an embodiment of the present invention. The processor 4 may cause the image 900 to appear on the screen 8a of the display 8 when a user clicks on field 738a in image 700 shown in FIG. 8

The image 900 includes symbols or designations 902a, 902b, 902c, 904a, 904b, 904c, 904d, 904e, 904f, 906a, 906b, 906c, 906d, 906e, 908, 908a, 910, 912, 914, 916, and 918 similar to symbols or designations 102a, 102b, 102c, 104a, 104b, 104c, 104d, 104e, 104f, 106a, 106b, 106c, 106d, 106e, 108, 108a, 110, 112, 114, 116, and 118 in FIG. 8.

The image 900 further includes fields 920 and 922, which allow the user to sign out of the search engine service and to access the home page shown in FIG. 6 of the search engine service. Fields 924, 924a, 924b, 924b, 924c, 924d, 924e, 924f, and 924g in FIG. 10 have the same function as fields 719, 722, 724, 726, 728, 730, 732, and 732a, respectively, in FIG. 8. Field 944 in FIG. 10 has the same function as the combination of fields 744, 746, and 748 in FIG. 8. Fields 946, 946a and 946b in FIG. 10 have the same function as field 750 in FIG. 8. Fields 948, 950, and 952 in FIG. 10 have the same functions as fields 752, 754, and 756, respectively, in FIG. 8. Fields 954 and 956 in FIG. 10 have the same function as fields 766 and 772, respectively, in FIG. 8.

The image 900 also includes fields 926, 928, 930, 932, 934, 936, 938, 940, and 942. Field 926 when clicked on causes the screen 8a of the display 8 to display e-mails. Field 928 when clicked on deletes the e-mail whose information appears in fields 936 and 938. Field 930 when clicked on will open a web page similar to image 900 but without the text shown in field 938 so the user can type his or her message to another user with the data in field 1436 already filled in. Field 932 when clicked on causes the image 800 in FIG. 9 to be displayed on screen 8a with all of the information filled, except that the user has to enter the people he or she wants to forward the e-mail to in field 822 of FIG. 9. Field 934 when clicked on causes the screen 8a of the display 8 to display the next message. Currently message “1” of “7” is being displayed. Field 936 shows who the current e-mail is from, the date sent, whom it was sent to, and the subject of the e-mail. Field 938 shows the text of the e-mail message. Field 940 and 942 are scroll up and down triangles or arrows. The scroll arrows 940 and 942 are needed for messages typed in field 1438 that are too long for a single page on the screen 8a.

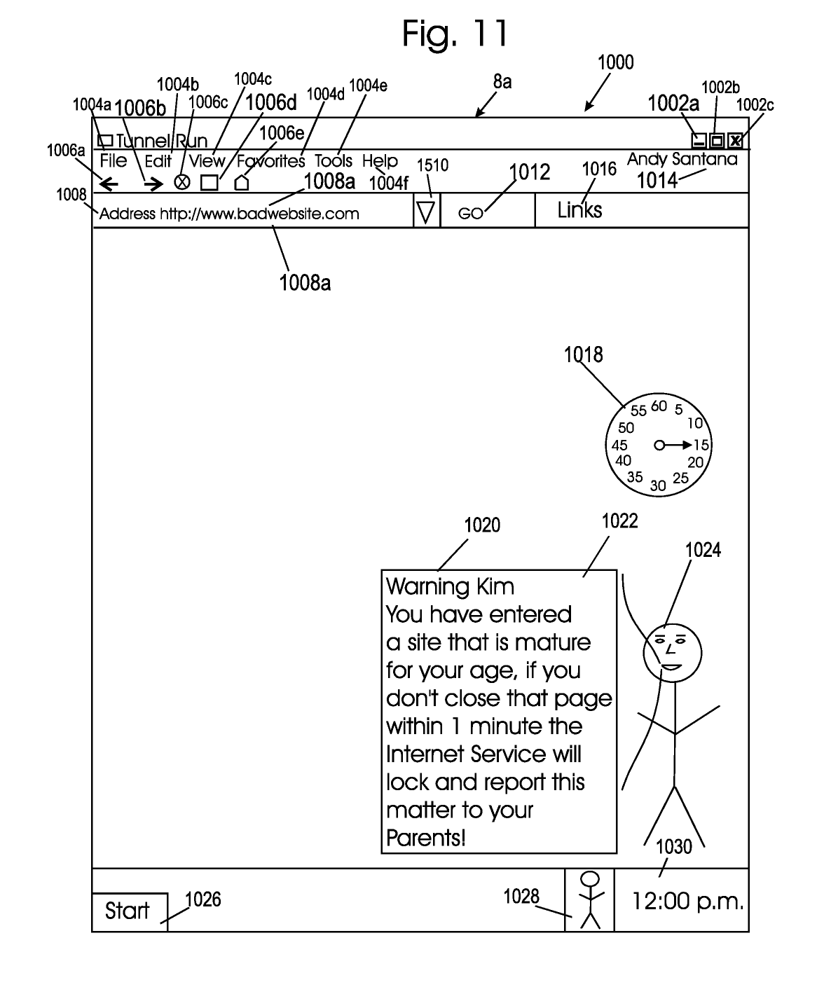

FIG. 11 shows a tenth computer display image 1000 on the screen 8a of the display 8 to be provided in accordance with an embodiment of the present invention. The processor 4 may cause the image 1000 to appear on the screen 8a of the display 8 when a child has entered a web site which is too mature for their age. The image 1000 includes a warning message 1022 in field 1020. If the child doesn't close the web site the processor 4 or a server processor will sign the child off of the web site and send a message to the main user concerning what web site the child was viewing. The search service will prevent the child from using the internet until the parent uses its password.

The image 1000 includes symbols or designations 1002a, 1002b, 1002c, 1004a, 1004b, 1004c, 1004d, 1004e, 1004f, 1006a, 1006b, 1006c, 1006d, 1006e, 1008, 1010, 1012, 1014 , and 1016 similar to symbols or designations 102a, 102b, 102c, 104a, 104b, 104c, 104d, 104e, 104f, 106a, 106b, 106c, 106d, 106e, 108, 110, 112, 114, and 116 in FIG. 2.

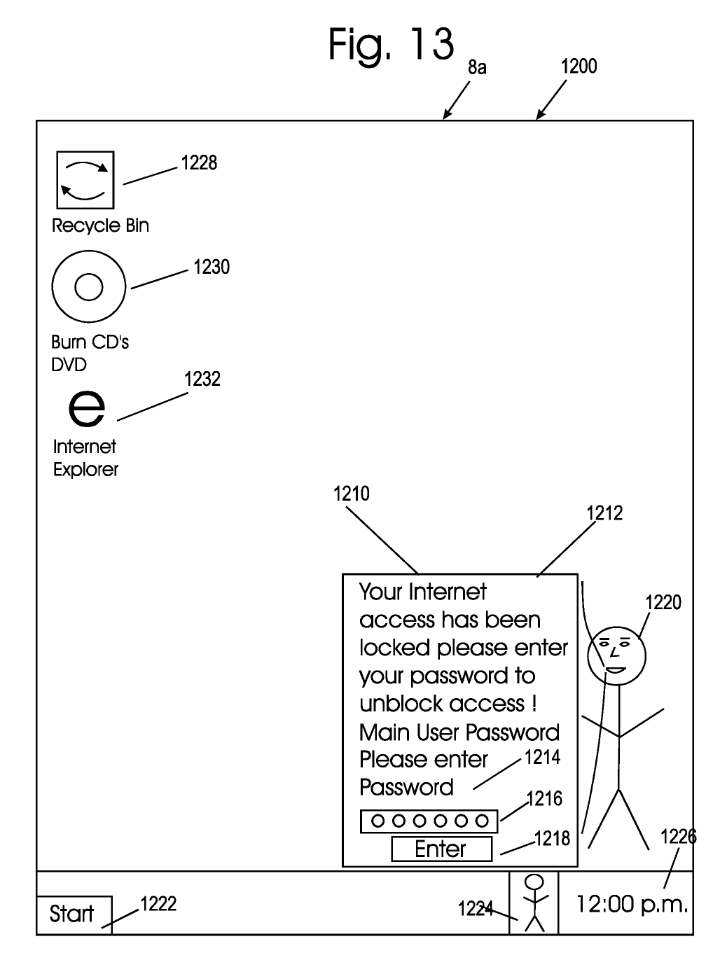

The image 1000 includes an image 1018 which displays the time that the child has left to close the web page or get out of the web site. If the child does not close the web page, then the image 1200 in FIG. 13 appears and the search engine service will log off the user from the web site and the internet. However, if the user closes the web page before the time runs out then the user can still surf the web, i.e. search the internet.

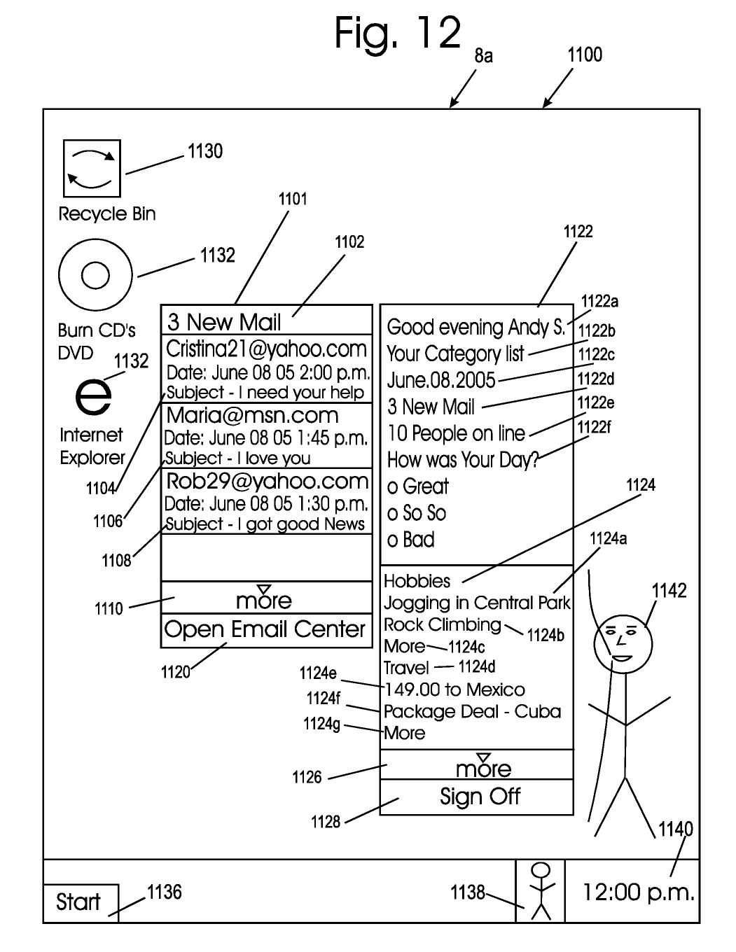

The image 1000 includes a guide 1024 which may be an image which appears to guide the user through the search engine service. The guide 1024 may light up its eyes to put a little fear into the child to leave the particular web site. Field 1026 is the start field on a typical desktop. Field 1028 indicates that the guide feature for guide 1024 is active on the user computer 1. Field 1028 will light up when the user is connected to the search service and it's a shortcut so a user can click on it and it will open up the guide part of the computer program for the internet search engine service of the present invention. Field 1030 is a typical time field for a desktop page of a computer. When the guide program is first opened up, the image 1100 in FIG. 12 will be displayed on the screen 8a. Field 1008a is the internet address of the web site that the child is viewing, that they shouldn't be viewing. Field 1028 is typically displayed when the user has downloaded the guide feature.

FIG. 12 shows an eleventh computer display image 1100 on the screen 8a of the display 8 to be provided in accordance with an embodiment of the present invention. The processor 4 may cause the majority or rest of the image 1100 to appear on the screen 8a of the display 8 when the shortcut section or field1 138 is clicked on. Field 1 138 will remain on after the rest of image 1100 is displayed on screen 8a.

The image 1100 includes fields 1130, 1132, and 1134 which are standard computer software shortcuts that Microsoft Windows (trademarked) presents on a computer desktop page. Other shortcuts may be provided depending on user's settings. Field 1130 shows a recycle bin symbol and text, which when clicked on leads to a known process. Field 1132 when clicked on lead to a known burn CD process. Field 1134 when clicked on leads to the known Internet Explorer (trademarked) web browser.

When image 1100 is opened, field 1138 just turns red indicating the service is online.

The image also includes field 1122 which appears when the operator of the user computer 1 clicks on the field 1136 including the symbol for the guide. When a user places their cursor on the field 1122d “three new e-mail”, the window or field 1101 will be displayed or pop out on screen 8a. Field 1122 includes fields 1122a, 1122b, 1122c, 1122d, 1122e, and 1122f. The field 1122a displays a greeting when a user of user computer 1 first logs in to the search engine in accordance with the present invention. The greeting in field 1122a may be “Good morning”, “Good afternoon” or “Good evening” depending on the time of day, and the user's name, for example, “Andy S”.

The field 1122b can be clicked on to show a list of categories the user has chose. The field 1122c displays the current date. The field 1122d can be clicked on to display the e-mail section field 1101. The field 1122d shows how many e-mails have been sent to the user and is displayed if the user has an e-mail account with the search engine service. Field 1101 pops out, i.e. is displayed on the screen 8a when the user clicks on field 1122d.

Field 1101 displays a listing of all the e-mail sent to the user. Field 1101 may be called the e-mail section. The field 1101 includes heading field 1102, and message fields 1104, 1106, and 1108. Each of fields 1104, 1106, and 1108 includes an e-mail address, a date, and a subject. If a user wants to view the content of a message the user would click on the appropriate field 1104, 1106, or 1108 and then the appropriate message will be displayed on screen 8a, as shown for example in FIG. 10.

Field 1101 also includes the field 1110 which when clicked on displays more e-mails in window or field 1101 if there are more in the list. Field 1120 when clicked on will display the email main page shown in FIG. 8 to view all the user's e-mail on the search engine service account and send an email to any other person.

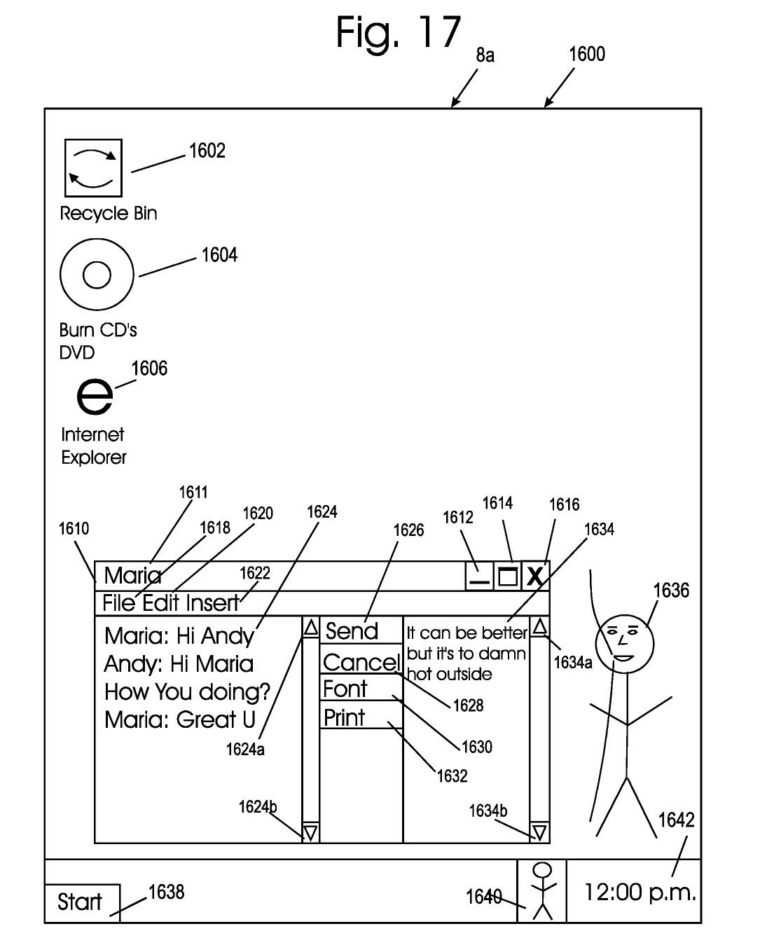

Field 1122e indicates how many people that the user regularly communicates with in the service are online. Field 1122e may pop up, or be displayed on screen 8a, similar to field 1101. Clicking on field 1122e may display all the user screen names, similar to field 1601, and to speak to them, the user typically just has to double click on their name and screen 1900 shown in FIG. 17 would appear.

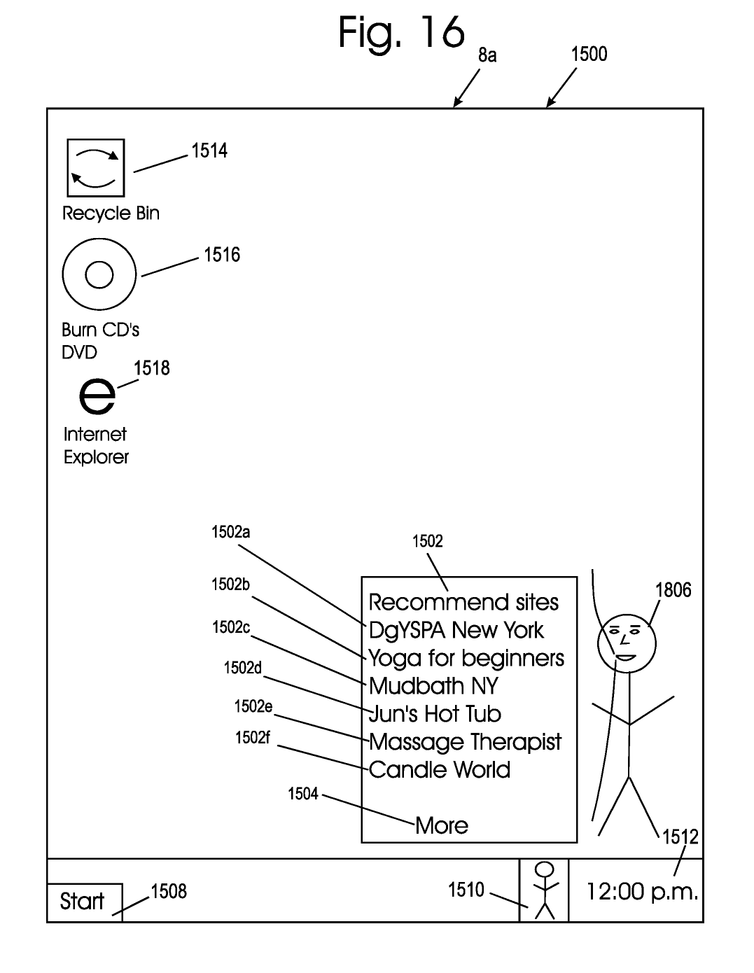

Fields 1122f displays question for the user to answer so the search engine service can recommend web sites depending on the answers the user picks. For example, the user can click on the circle next to either “Great”, “So So”, or “Bad” to answer the question “How was your day?” in field 1122f. Once the user clicks on an answer in field 1122f, then the search engine service will suggest a web site that the user can view by displaying the name of the web site on screen 8a. Everyday there may be a different question and there may be different questions on the same day as well. FIG. 16 and FIG. 6 Field 596 shows a display of possible web sites to visit. The web sites provided by the service may be based on the response to the “How was your day?” question or whatever question was used. A small pop-up menu may appear on top of field 1638 and the small box may show sites recommended.

Field 1124 is displayed when the user filled in the questionnaire from FIGS. 2 and 3. The search engine service will provide web sites regarding the various topics when the user chooses the topic. If a user clicks on the hobby for entry 1124a or entry 1124b the processor 4 or server processor will display web sites for that particular hobby. The user can display more hobby choices by clicking on field 1124c for “More”.

Field 1124d is a heading for travel. Field 1124e shows the price of a flight to Mexico and field 1124f refers to a package deal to Cuba. Clicking on either field 1124d or field 1124e causes a display of information regarding those travel offers. Field 1124g, when clicked, on causes more information, regarding travel offers, to be displayed.

Field 1126, when clicked, on will display more choices for the Hobbies and Travel topics. Field 1128, when clicked on, will sign the user off of the search engine service and disconnect the user from their customized web page, i.e. image 1100. The field 1138, when clicked on, will cause the image 1100 to be displayed. The processor 4 or a server processor, may cause an icon in field 1138 or field 1138 to blink with different colors to notify the user if there is any new information displayed or new email or someone signed on.

The image 1100 may also include field 1136 which is a start field is typically provided for in Microsoft Windows as known in the art. Field 1140 shows the current time.

FIG. 13 shows a twelfth computer display image 1200 on the screen 8a of the display 8 to be provided in accordance with an embodiment of the present invention. The processor 4 may cause the image 1200 to appear on the screen 8a of the display 8 when the internet or search service has been locked and a user thereafter tries to get on the internet by clicking on the internet explorer (trademarked) icon, such as field 1232 in FIG. 13. If the correct password is typed in field 1216 and entered by clicking on field 1218, then the internet can be accessed and the image 500 shown in FIG. 6 will be displayed by the computer processor 4 or a server processor.

The image 1200 includes a window 1210. The window 1210 includes text 1212 indicating that internet access for the operator or user of user computer 1, has been blocked. A password is requested by text 1214. An entry designation 1216 allows a six-character password to be entered. More than six characters can be allowed for. A designation 1218 for “Enter” when clicked on, caused the password entered into designation 1216 to be processed by processor 4 and if the password is correct the processor 4 or a server processor will allow access to the internet.

The image 1200 includes a guide or navigation buddy image 1220. If the user of user computer 1 doesn't want to use the navigation buddy image 1220, the user can change that feature so that buddy image 1220 doesn't appear. For example, the processor 4 or server processor running the search engine can be programmed so that when user right clicks on image 1220 an option will be displayed on screen 8a, which will give the choice of displaying the buddy image 1220 or not displaying the buddy image 1220. The image 1200 further includes a start designation 1222, which normally appears on a computer desktop as known in the art. The image 1200 also includes a symbol 1224 to indicate that a computer program for the navigation buddy or navigation buddy image 1220 on the processor 4 is active. The symbol or image 1224 is a shortcut which can be clicked on the activate the buddy 1220, that will display on FIG. 11 through FIG. 18, and will also indicate if the user is currently on the search engine service or currently online on the internet. A time designation 1226 of the current time, which is shown as “12:00 p.m.” is also shown in the image 1200. Fields 1222 and 1226 are standard fields for standard applications that Microsoft Windows (trademarked) presents.

The image 1200 also includes images 1228, 1230, and 1232 which are similar to fields 1130, 1132, and 1134, respectively, shown in FIG. 12.

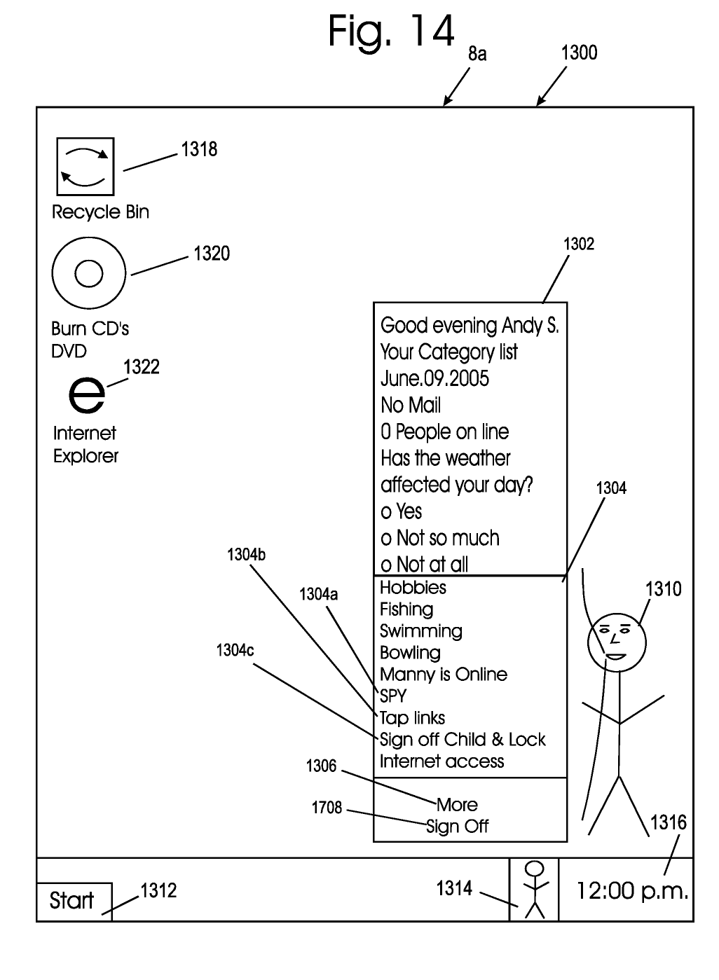

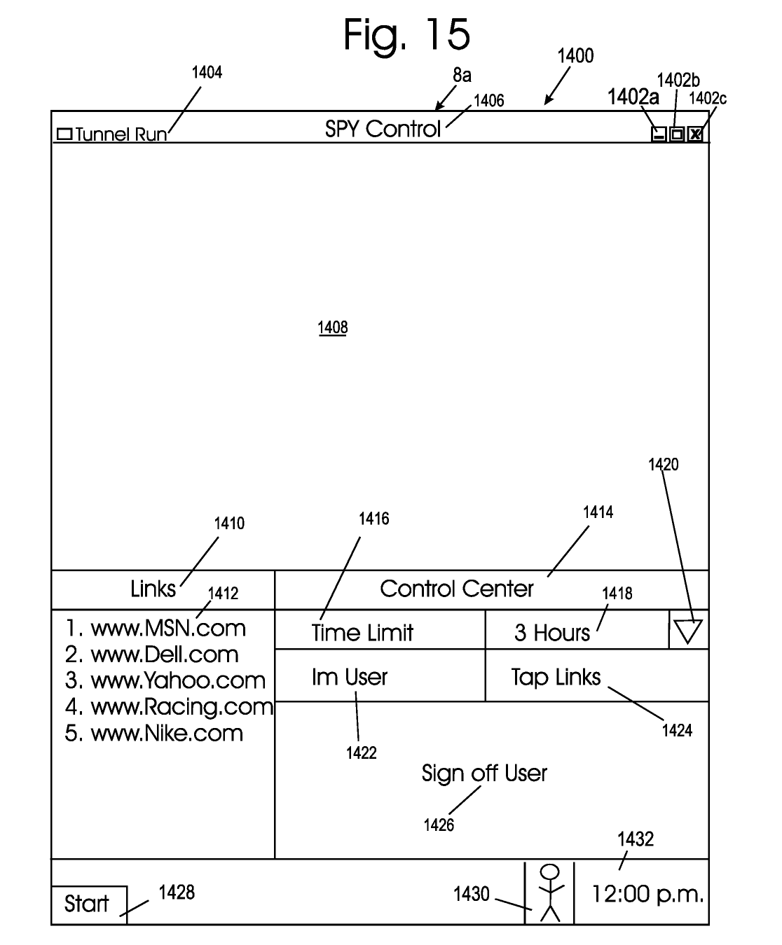

FIG. 14 shows a thirteenth computer display image 1300 on the screen 8a of the display 8 to be provided in accordance with an embodiment of the present invention. The processor 4 may cause the majority of the image 1300 (the fields above fields 1312, 1314, and 1316) to appear on the screen 8a of the display 8 when the user clicks on the field 1314. FIG. 14 is the main user access. In field 1704, the statement “Manny is Online” refers to a child or dependent user or operator. The main user can click on the field 1704a for “Spy” to spy on Manny which would bring up image 1400 shown in FIG. 15. When the main user places their computer cursor over “Manny is Online” a small window may pop up on screen 8a which shows in real time what the child is viewing such as a web site or the computer desktop. The child or dependent user may have his or her own password but the main user can over ride that and check on the child when the child is using the user computer 1 or some other computer.

The image 1300 includes fields 1318 for a recycle bin, field 1320 for a Burn CD's DVD, and field 1322, when clicked on, causes the internet explorer web browser to be activated. Fields 1318, 1320, and 1322 are known Microsoft Windows (trademarked) computer software shortcuts. Different computer software shortcuts or icons may be displayed depending on settings set by the user.

The image 1300 also includes field 1302 which is similar to field 1122 of FIG. 12, except that the field 1302 displays a child's account for the search engine service. Whenever a child user uses the internet and the main user A.K.A. parent user is online as well, the parent will be able to view what the child is viewing on FIG. 15 field 1408.

If the parent wants they can have this auto sign in feature on this service. In accordance with this feature, the child or dependent user can only depend on this service and is not allowed to navigate to other search engines known as Yahoo (trademarked), Google (trademarked), Etc. so the parent which is the main user can check what the child is viewing on FIG. 15. The child can surf the web but the parent which is the main user can view the child searches on FIG. 15, field 1408 and field 1410. If the child tries to create another account they can't because they would need the parent's main user password to gain access to it.

The image 1300 also includes field 1304a which may be called the spy button, which when clicked on will allow the main user to view at real time what the child is viewing. In this case the child would be on a first computer using the search engine of the present invention and the parent would be on a second computer using the search engine of the present invention. The field 1304a is available when the easy access shortcut is downloaded by clicking on field 1138 shown in FIG. 12.

The image 1300 includes field 1304b which allows a parent user to tap the web site links that a child user has viewed. The web site links may be sent to the main user's e-mail account so that the main user can see what their child has been viewing on line.

Field 1304c allows the main or parent user to sign off the child from the search engine and thus from the internet and to lock internet access from another computer. For the child to regain access the main user needs to provide their password.

Field 1306 when clicked on may provide further user customized information (such as hobbies etc. depending on what the user previously entered onto images 200 and 300 in FIGS. 2 and 3, respectively. Field 1308 allows the main user to sign off from the search engine service. Field 1312 is a start from a desktop menu. Field 1314, when clicked on, displays the guide 1310. Field 1316 shows a time.

FIG. 15 shows a fourteenth computer display image 1400 on the screen 8a of the display 8 to be provided in accordance with an embodiment of the present invention. The processor 4 may cause the image 1400 to appear on the screen 8a of the display 8 when user clicks on FIG. 14 field 1304a.

The image 1400 includes fields 1402a, 1402b, 1402c, 1404, 1406, 1408, 1410, 1412, 1414, 1416, 1418, 1420, 1422, 1424, 1426, 1428, 1430, and 1432. The fields 1402a, 1402b, and 1402c are similar to fields 102a, 102b, and 102c, respectively, shown in FIG. 2. Field 1404 shows a fixed heading for the search engine service. Field 1406 displays the phrase “SPY Control”. Field 1410 displays a fixed heading for “Links”. Field 1412 shows links that dependent user is viewing in real time, i.e. the main user can be spying on, for example, a child (or dependent or secondary user). Field 1408 shows an image of what the other user (such as child user) is actually viewing, such as a particular web site page.

Field 1426 can be clicked on to allow the main user to sign off the child user. Once the main user signs the child user off, the child (or dependent user) can't access the internet until the main user unlocks the internet for the child user. Field 1424 can be clicked on to cause the entire child web site viewing history for a session to be sent to the e-mail of the main user. Thus if a child user logs onto the internet and views twenty web site pages, the list of the twenty web site page addresses would be sent to the e-mail of the main user when field 1424 is clicked on.

Field 1416 is a fixed heading stating “Time Limit”. Field 1420 is a scroll arrow which can be clicked on by the main user to set a time limit that the dependent user can be on the internet. Field 1418 displays the time limit which has been selected which is currently “3 Hours”. When the time limit is up search engine service computer program running on the processor 4 or server processor will automatically sign the dependent user off and prevent internet access from the user computer 1 until the main user unlocks by entering a password.

Field 1422 can be clicked on by the main user to internet message the child user that is being watched or spied on.

Fields 1428, 1430, and 1432 are similar to fields 1026, 1028, and 1030, respectively, shown in FIG. 11.

FIG. 16 shows a fifteenth computer display image 1500 on the screen 8a of the display 8 to be provided in accordance with an embodiment of the present invention. The processor 4 may cause the image 1500 to appear on the screen 8a of the display 8 when the main user clicks on the auto search feature, field 638 shown in FIG. 7A. Field 1502 shows the results of the auto search.

The image 1500 includes fields 1514 for a recycle bin, field 1516 for a Burn CD's DVD, and field 1518, when clicked on, causes the internet explorer web browser to be activated. Fields 1514, 1516, and 1518 are known Microsoft Windows (trademarked) computer software shortcuts. Different computer software shortcuts or icons may be displayed depending on settings set by the user.

The image 1500 also includes field 1502 which recommends internet web sites (by displaying them) once the user enters answers to the questions in field 1622f in FIG. 17. The web sites are listed by topics in fields 1502a-f and not by internet address. For example, a user can click on the field 1502b which indicates “Yoga for beginners” and then a web site corresponding to this topic will pop up. The image 1500 also includes the guide image 1506, start field 1508, guide icon or field 1510 and time indication 1512.

FIG. 17 shows an sixteenth computer display image 1600 on the screen 8a of the display 8 to be provided in accordance with an embodiment of the present invention. The processor 4 may cause the image 1600 to appear on the screen 8a of the display 8 when the main user clicks on field 1122e (“10 People on line”) shown in FIG. 12

The image 1600 includes fields 1602 for a recycle bin, field 1604 for a Burn CD's DVD, and field 1606, when clicked on, causes the internet explorer web browser to be activated. Fields 1602,1604, and 1606 are known Microsoft Windows (trademarked) computer software shortcuts. Different computer software shortcuts or icons may be displayed depending on settings set by the user.

The image 1600 includes an instant message window or section 1610. The window or section 1610 allows the user of user computer 1 to communicate via the internet with anyone else using the search engine in accordance with the present invention. The window or section 1610 displays what another user has wrote to the user and what the user is sending to the other user as text.

The window or section 1610 includes a window 1634 which is where the user types their message to send to the other user. The window or section 1610 includes a field 1632 designated as “Print” which when clicked on by the user causes the text of window 1610 (including window 1634) to be printed. The image includes a field 1630 designated as “Font” which when clicked on allows the user to change the font (such as the color or size) of the text in window 1634. The window or section 1610 also includes a field 1628 which when clicked on causes the entire window 1610 to be canceled and to close, i.e. be no longer displayed on the screen 8a.

Fields 1618, 1620, and 1622, when clicked on, allow a user to open files, edit the work, and to insert a document to send to the other user, respectively.

The window 1610 also includes field 1626, which when clicked on, sends a text message to the other user.

The window 1610 includes a title 1611 for Maria. The window 1610 includes fields 1612, 1614, and 1616 which minimize the window 1610, maximize the window 1610, and close the window 1610, respectively. The fields 1624a and 1624b scroll up and down, respectively, the text of an instant message conversation via the internet. The fields 1634a and 1634b scroll up and down, respectively, the text typed in window 1634.

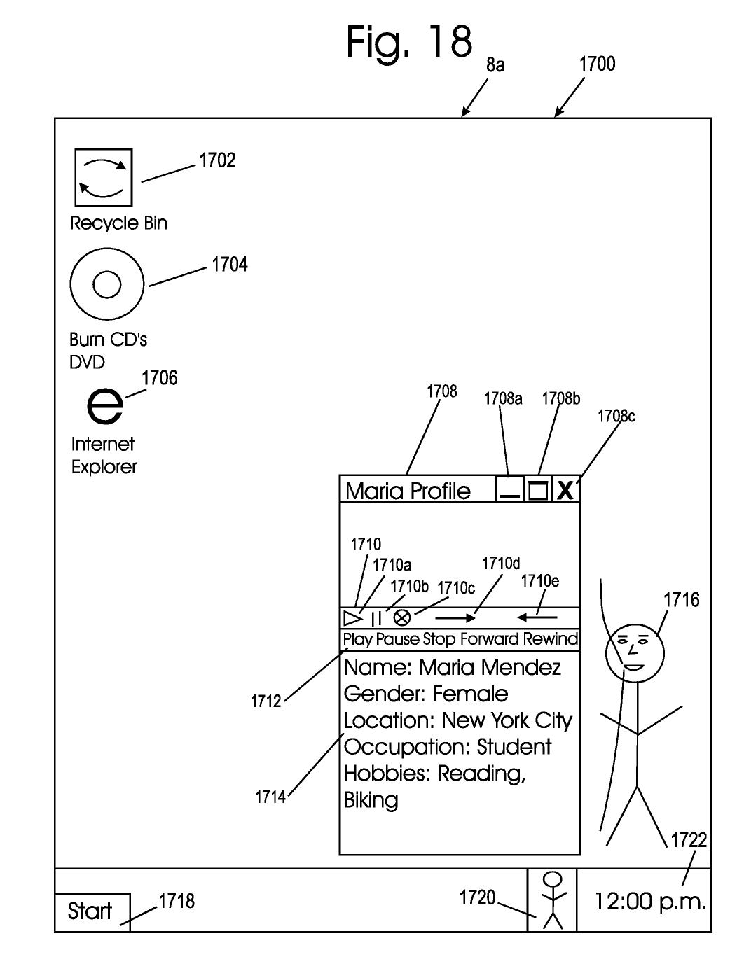

FIG. 18 shows a seventeenth computer display image 1700 on the screen 8a of the display 8 to be provided in accordance with an embodiment of the present invention. The processor 4 may cause the image 1700 to appear on the screen 8a of the display 8 when the main user clicks on field 556 (“Get Member Profile”) shown in FIG. 6. FIG. 12 field 1126 and FIG. 14 field 1306 have that feature as well.

The image 1700 includes field 1702 for a recycle bin, field 1704 for a Burn CD's DVD, and field 1706, when clicked on, causes the internet explorer web browser to be activated. Fields 1702, 1704, and 1706 are known in the art.

The image 1700 also includes a profile window or section 1708. The profile window or section 1708 includes information concerning another user who is a member of the search engine internet service and is currently online or connected. The window 1708 may include a video window 1709 which may display a video of the particular member such as “Maria” or any other video that the other user.

The window 1708 includes fields 1708a, 1708b, and 1708c which minimize, maximize, and close the window 1708. The window 1708 includes the field 1710 which includes fields 1710a, 1710b, 1710c, 1710d, and 1710e including symbols which when clicked on, play, pause, stop, forward, or rewind the video in window 1709. Field 1712 shows text designations for these various functions.

The window 1708 also includes a section 1714 which describes the other user, in this case a description of “Maria Mendez”. The information in section 1714 is typically information that the user wants to present for a profile.

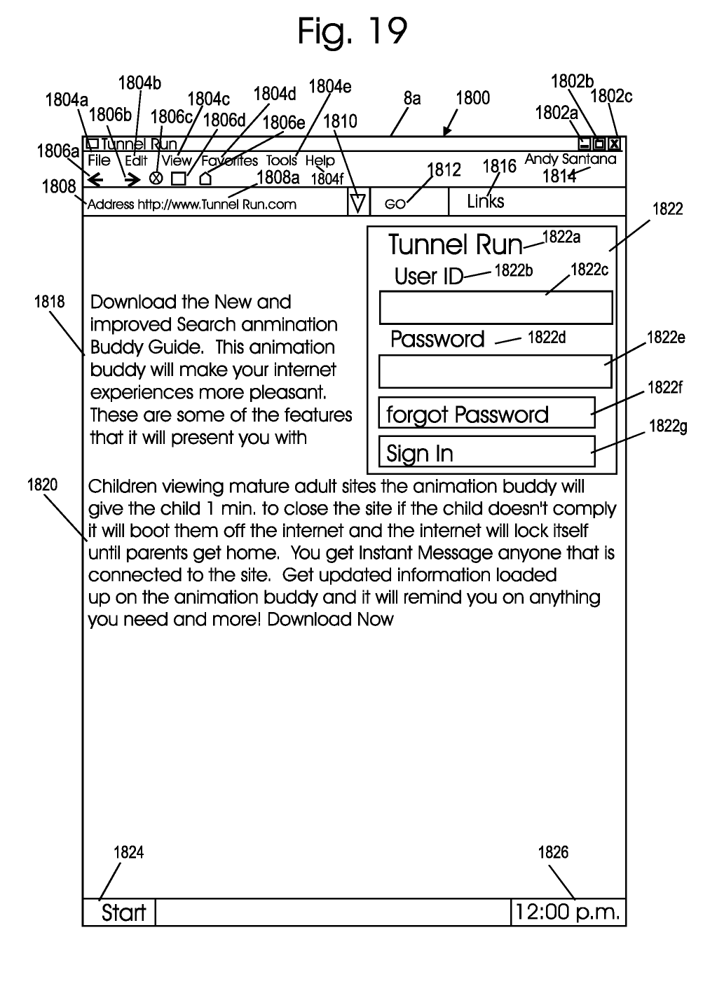

FIG. 19 shows a eighteenth computer display image 1800 on the screen 8a of the display 8 to be provided in accordance with an embodiment of the present invention. The processor 4 may cause the image 1800 to appear on the screen 8a of the display 8 when a user signs off from any of the images shown in FIGS. 6-10.

The image 1800 includes symbols or designations 1802a, 1802b, 1802c, 1804a, 1804b, 1804c, 1804d, 1804e, 1804f, 1806a, 1806b, 1806c, 1806d, 1806e, 1808, 1808a, 1810, 1812, 1814, and 1816 and similar to symbols or designations 102a, 102b, 102c, 104a, 104b, 104c, 104d, 104e, 104f, 106a, 106b, 106c, 106d, 106e, 108, 108a, 110, 112, 114, and 116 in FIG. 2.

The image 1800 further includes various fields which allow a user to sign in to the search engine in accordance with the present invention. Field 1818 shows text regarding a search animation buddy guide in accordance with the present invention. Field 1820 includes text regarding the features of the search animation buddy guide.

The image 1800 further includes field 1822, which includes field 1822a which includes text for “Tunnel Run” the name of the computer software for the search engine or buddy guide. The image 1800 also includes field 1822b which states “User Id”, field 1822c where a user identification can be entered, field 1822d which states “Password”, and field 1822e where a user password can be entered. The image 1800 also includes field 1822f which can be clicked on to indicate that a password has been forgotten and field 1822g which can be clicked on to sign in. The image 1800 also includes a field 1824 for starting computer programs and a field 1826 which displays the current time.

The host computer 12 shown in FIG. 1 may include computer program known as a search engine. The search engine or part of the search engine may run on both the host computer 12 and on the user computer 1. A user of user computer 1 may set up a user-personalized page such as the page shown in image 100 of FIG. 2. The user's personalized page such as image 100 may specify web sites available depending on what is selected by the user on FIG. 3. What is shown in FIG. 3, gives suggestions to the user, such as displaying web sites pages or content for different web sites for example in the three columns below field 596 in FIG. 6.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. An apparatus comprising:
a computer processor;
wherein the computer processor is programmed to provide a search engine service to one or more members;
wherein the search engine service assists each member in accessing the internet;
wherein the search engine service causes a navigation buddy to be displayed on a computer monitor screen;
wherein the navigation buddy is a displayed character; and
wherein the search engine service causes output information to be displayed on the computer monitor screen along with the navigation buddy so that it appears that the output information is being provided by the navigation buddy.

2. The apparatus of claim 1 wherein
the search engine service is programmed to receive input information from a main user;
and wherein the output information is based at least in part on the input information provided by the main user.

3. The apparatus of claim 2 wherein
the input information includes goal information referring to the main user.

4. The apparatus of claim 2 wherein
the input information includes hobby information referring to the main user.

5. The apparatus of claim 2 wherein
the input information includes marital status information referring to the main user.

6. The apparatus of claim 2 wherein
the input information includes information about people other than the main user.

7. The apparatus of claim 2 wherein
the input information includes information about people other than the main user, wherein the people are known to the main user.

8. The apparatus of claim 2 wherein
the input information includes information about the main user's current mood.

9. The apparatus of claim 1 wherein
the output information includes information concerning one or more web sites.

10. An apparatus comprising:
a computer processor;
wherein the computer processor is programmed to provide a search engine service to one or more members;
wherein the search engine service assists each member in accessing the internet;
wherein the search engine service is programmed to allow a main user to prevent a dependent user from accessing the internet from a main user computer.

11. A method comprising
causing a navigation buddy to be displayed on a computer monitor screen;
wherein the navigation buddy is a displayed character; and
causing output information to be displayed on the computer monitor screen along with the navigation buddy so that it appears that the output information is being provided by the navigation buddy; and
wherein the output information refers to internet web sites.

12. The method of claim 1I1 further comprising
receiving input information from a main user;
and wherein the output information is based at least in part on the input information provided by the main user.

13. The method of claim 12 wherein
the input information includes goal information referring to the main user.

14. The method of claim 12 wherein
the input information includes hobby information referring to the main user.

15. The method of claim 12 wherein
the input information includes marital status information referring to the main user.

16. The method of claim 12 wherein
the input information includes information about people other than the main user.

17. The method of claim 12 wherein
the input information includes information about people other than the main user, wherein the people are known to the main user.

18. The method of claim 12 wherein
the input information includes information about the main user's current mood.
